(19) United States
(12) Patent Application Publication
(10) Pub. No.: US 2015/0002293 A1
(43) Pub. Date: Jan. 1, 2015

(54) System and method for disseminating information and implementing medical interventions to facilitate the safe emergence of users from crises

(71) Applicant: Michael Nepo, Woodside, NY (US)

(72) Inventor: Michael Nepo, Woodside, NY (US)

(21) Appl. No.: 14/043,531

(22) Filed: Oct. 1, 2013

Related U.S. Application Data
(63) Continuation-in-part of application No. 13/928,110, filed on Jun. 26, 2013.

(51) Int. Cl. G08B 21/02

(52) U.S. Cl. CPC G08B 21/02
USPC 340/539.13; 340/539.11

(57) ABSTRACT

A method for disseminating information regarding a problem and administering medical interventions comprises providing a mobile device wirelessly connectable to a network, receiving and storing contact information corresponding to a designated list of information recipients, receiving, via the mobile device, a signal from a user indicating the problem, receiving, via the mobile device, information regarding the problem, transmitting an indication of the problem to a rescue clearinghouse via the network, prompting a participant of the rescue clearinghouse, different from the user, to make a decision about a course of action regarding the problem, and at least one of transmitting the information regarding the problem to the information recipients from the designated list and transmitting the information regarding the problem to a government rescue organization, based at least in part on the decision.

### REFERENCE TO RELATED APPLICATIONS

This application is a continuation-in-part claiming the benefit of U.S. Non-Provisional patent application Ser. No. 13/928,110, filed Jun. 26, 2013, entitled “System and method for disseminating information and implementing medical interventions to facilitate the safe emergence of users from crises.”

### BACKGROUND OF THE INVENTION

Throughout history, millions of people faced life-threatening crises such as abductions, rape, sudden medical crises, car-jackings, robberies, and countless other dangerous situations. Historically, when a person found themselves in such a situation, it was impossible to instantly and discreetly alert loved ones and professional rescuers to the crisis, without alerting a potential attacker or abductor to the rescue attempt, and it was impossible to discreetly provide rescuers with data such as audio, video, geographical location, and instant communication amongst the various rescuers needed to understand the nature of the crisis, in order to enable rescuers to rapidly locate and rescue the user. Often, police lack the vital information and evidence needed to identify, capture and prosecute attackers, or to understand the detailed circumstances of any crisis from afar. Safety systems which require the user to engage in a verbal conversation with the rescuers are dangerous and not usable in a situation such as an abduction, because the attacker will hear the discussion with the dispatcher and terminate the communication. Safety systems which require users to interface with a smart phone screen to trigger a panic are impossible to discreetly and rapidly use during a sudden attack, because it takes too long for users to: A) awaken the phone screen, B) unlock the screen, C) locate the application, D) launch the application, and finally, E) trigger a panic within the application. No attacker would allow a user to retrieve their phone from their pocket and do the above actions during an attack. Throughout history, if a person was alone and lost consciousness, there was very little likelihood that they would have been rescued. Historically, victims of rape did not have available ways to deter a rapist from proceeding with the attack, by convincing the attacker that their identity and location is now known to the authorities. Historically, if a person experienced sudden cardiac arrest, there was a high likelihood that the person would die without immediate defibrillation. Historically, if a person needed a dose of medicine, it has been difficult for many users to administer the correct dosage at the correct times, particularly if a medical emergency rendered the user unconscious. Historically, if a person suffered a seizure, stroke or other brain related crisis, it was not possible to instantly notify rescuers of the crisis, and it was not possible to rapidly administer medicine needed to address the crisis. Historically, when a person embarked on any journey alone, including journeys on foot and in a car, if a sudden crisis emerged which caused the person to lose consciousness, subsequently causing the person to stop progressing towards their destination, it was not possible for help to be automatically summoned to the person's location.

As can be seen, there is a need for solutions to these and other problems.

### SUMMARY OF THE INVENTION

In one aspect of the present invention, a method for disseminating information regarding a problem, comprises: providing a mobile device wirelessly connectable to a network; receiving and storing contact information corresponding to a designated list of information recipients; receiving, via the mobile device, a signal indicating the problem; receiving, via the mobile device, information regarding the problem; transmitting an indication of the problem to a rescue clearinghouse via the network; prompting a participant of the rescue clearinghouse, different from the user, to make a decision about a course of action regarding the problem; and at least one of transmitting the information regarding the problem to the information recipients from the designated list and transmitting the information regarding the problem to a government rescue organization, based at least in part on the decision.

In another aspect of the present invention, a method for disseminating information regarding a problem further comprising a primary panic trigger device comprising a button, wherein receiving the signal indicating the problem is activated by the user double pressing the button on the primary panic trigger device, which signals the mobile device wirelessly.

In another aspect of the present invention, a method for disseminating information regarding a problem further comprising a head mounted camera comprising a button, wherein receiving the signal indicating the problem is activated by the user double pressing the button on the head mounted camera, which signals the mobile device wirelessly.

In another aspect of the present invention, a method for disseminating information regarding a problem wherein receiving the signal indicating the problem is activated by the mobile device detecting a preprogrammed verbal phrase.

In another aspect of the present invention, a method for disseminating information regarding a problem further comprising receiving and storing a specified area, wherein receiving the signal indicating the problem is activated by the mobile device either entering or exiting the specified area.

In another aspect of the present invention, a method for disseminating information regarding a problem further comprising the step of providing a g-force detector attached to the cell phone; and receiving and storing information of a threshold g-force amount, wherein receiving the signal indicating the problem comprises the mobile phone reaching the threshold g-force amount.

In another aspect of the present invention, a method for disseminating information regarding a problem further comprising providing a family plan comprising a plurality of mobile devices owned by multiple members of the same family.

In another aspect of the present invention, a method for disseminating information regarding a problem further comprising the step of detecting the location of the plurality of mobile devices on the family plan and displaying the locations on a shared family Internet website.

In another aspect of the present invention, a method for disseminating information regarding a problem further comprising providing a recording device connected to at bast one of the plurality mobile devices and configured to record at bast one of audio, video, and image; and recording at least one of audio, video, and image in real time via the recording device to produce recording information, wherein the information is displayed on the shared family Internet website.

In another aspect of the present invention, a method for disseminating information regarding a problem wherein the signal indicating the problem activates a silent panic or a bud panic, wherein the silent panic comprises transmitting an indication of the problem to a rescue clearinghouse via the network without detection, wherein the bud panic comprises transmitting an indication of the problem to a rescue clearinghouse via the network while the mobile device produces at bast one of a bud spoken warning, and an emitting light.

In another aspect of the present invention, a method for disseminating information regarding a problem wherein activating the bud panic comprises selecting a bud panic button icon displayed on a home screen of the mobile device.

In another aspect of the present invention, a method for disseminating information regarding a problem, comprises: providing a mobile device wirelessly connectable to a network; receiving and storing contact information corresponding to a designated list of information recipients; receiving, via the mobile device, coordinates of an intended destination; tracking the movements of the mobile device from a current location to the intended destination; transmitting an indication of a problem to a rescue clearinghouse via the network when the mobile device is either no longer moving or is deviating from routes which lead to the intended destination; prompting a participant of the rescue clearinghouse, different from the user, to make a decision about a course of action regarding the problem; and at least one of transmitting the information regarding the problem to the information recipients from the designated list and transmitting the information regarding the problem to a government rescue organization, based at least in part on the decision.

These and other features, aspects and advantages of the present invention will become better understood with reference to the following drawings, description and claims.

### BRIEF DESCRIPTION OF THE DRAWINGS

FIG. 1 is an exemplary representation of the test panic home screen within the smartphone application;

FIG. 2 is an exemplary representation of the application screen shown after a test silent panic of FIG. 1 has been triggered;

FIG. 3 is an exemplary representation of the mobile rescue website of the present invention after a user has triggered a test panic of FIG. 1;

FIG. 4 is an exemplary representation of the desktop rescue website after the user has triggered a test panic of FIG. 1;

FIG. 5 is an exemplary representation of the application home screen of the present invention;

FIG. 6 is an exemplary representation of the application screen which appears after a silent panic of FIG. 5 has been triggered;

FIG. 7 is an exemplary representation of the application screen which appears after a loud panic of FIG. 5 has been triggered;

FIG. 8 is an exemplary representation of the application screen which appears after a medical panic of FIG. 5 has been triggered;

FIG. 9 is a perspective view of a designated physical panic trigger device of the present invention;

FIG. 10 is an exemplary representation of the user triggering silent panic, from FIG. 5;

FIG. 11 is a perspective view of a user selecting silent panic on an exemplary ear-mounted video camera of the present invention;

FIG. 12 is an exemplary representation of the application screen which appears after a silent panic of FIGS. 9 through 12 has been triggered;

FIG. 13 is an exemplary representation of the user's designated emergency contacts receiving a signal activated by the silent panic of FIGS. 9 through 12;

FIG. 14 is an exemplary representation of a designated Rescue Center receiving a signal activated by the silent panic of FIG. 9 through 12;

FIG. 15 is an exemplary representation of a user selecting the safe journey timer after the user selects the safe journey option from the application home screen of FIG. 5;

FIG. 16 is an exemplary representation of the application screen which appears after the user selects the safe journey timer option of FIG. 15;

FIG. 17 is an exemplary representation of the application screen which appears after the user starts the safe journey timer of FIG. 16;

FIG. 18 is an exemplary representation of the safe journey timer countdown screen of FIG. 17 reaching a designated countdown time, at which time the user may be notified that the countdown is nearly complete;

FIG. 19 is an exemplary representation of the silent panic screen which appears after the timer of FIG. 18 runs to zero;

FIG. 20 is an exemplary representation of the user's designated emergency contacts receiving a signal activated by the timer of FIG. 18;

FIG. 21 is an exemplary representation of a designated rescue center receiving a signal activated by the timer of FIG. 18;

FIG. 22 is a front view of the panic trigger device of FIG. 9;

FIG. 23 is a side view of the panic trigger device of FIG. 9 with an exemplary metal clip;

FIG. 24 is a bottom view of the panic trigger device of FIG. 9 with an exemplary USB port;

FIG. 25 is an perspective view of a a standard USB cord that may connect to USB port of the panic trigger device of FIG. 24;

FIG. 26 is an exemplary representation of the rescue website component of the present invention;

FIG. 27 is an exemplary representation of the rescue website displayed on a smart phone or other Internet-enabled device;

FIG. 28 is an exemplary representation of the present invention after a user selects press for menu items of FIG. 27;

FIG. 29 is an exemplary representation of the present invention after a user selects the user location history button of FIG. 28;

FIG. 30 is an exemplary representation of the present invention after a user selects the audio from scene button of FIG. 28;

FIG. 31 is an exemplary representation of the present invention after a user selects the help me button of HG. 28;

FIG. 32 is an exemplary representation of the present invention providing directions to the user after a different user enters a street address into the field described in FIG. 31;

FIG. 33 is an exemplary representation of the present invention after a user selects the photo/video button of FIG. 28 or FIG. 32;

FIG. 34 is an exemplary representation of the present invention after a user selects the video currently streaming live of FIG. 33;

FIG. 35 is a perspective view of the ear mounted video camera of FIG. 11 taking video of an exemplary attacker;

FIG. 36 is an exemplary representation of the transdermal medicine distribution patch with the medicine shield dosed, sealing off the medicine reservoir;

FIG. 37 is an exemplary representation of the transdermal medicine distribution patch of FIG. 36 with the medicine shield open, exposing the medicine reservoir;

FIG. 38 is an exemplary representation of a user selecting the safe journey button of FIG. 5 and FIG. 15;

FIG. 39 is an exemplary representation of a user selecting the safe journey monitor button;

FIG. 40 is an exemplary representation of a user starting the safe journey monitor after entering their designated destination;

FIG. 41 is an exemplary representation of a user ailing to continue traveling towards their designated destination;

FIG. 42 is an exemplary representation of the user's smartphone vibrating to warn them of the imminent panic triggering as a result of FIG. 41;

FIG. 43 is an exemplary representation of the users smartphone vibrating to warn them of the imminent panic triggering as a result of the smartphone detecting strong g-forces consistent with dangerous situations, such as a car accident;

FIG. 44 is an exemplary representation of a silent panic triggering as a result of completed countdowns from FIG. 42 or FIG. 43;

FIG. 45 is an exemplary representation of the user's designated emergency contacts receiving a signal activated by the silent panic of FIG. 44;

FIG. 46 is an exemplary representation of a designated Rescue Center receiving a signal activated by the silent panic of FIG. 45;

FIG. 47 is an exemplary representation of user speaking a designated phrase in order to trigger a silent panic;

FIG. 48 is an exemplary representation of an attacker threatening the user of FIG. 47;

FIG. 49 is an exemplary representation of the smartphone detecting the spoken designated panic trigger phrase, causing it to trigger a silent panic;

FIG. 50 is an exemplary representation of a silent panic triggering as a result of FIG. 49:

FIG. 51 is an exemplary representation of the user's designated emergency contacts receiving a signal activated by the silent panic of FIG. 50;

FIG. 52 is an exemplary representation of a designated rescue center receiving a signal activated by the silent panic of FIG. 50;

FIG. 53 is an exemplary representation of the rescue website displaying the user to be located within a safe perimeter;

FIG. 54 is an exemplary representation of the rescue website displaying the user to be located outside the designated safe perimeter;

FIG. 55 is an exemplary representation of the rescue website displaying three members of one family, during a non-dangerous non-panic situation;

FIG. 56 is an exemplary representation of the rescue website after one family member triggered a silent panic;

FIG. 57 is an exemplary representation of a user selecting the instantly launched and activated loud panic from the smartphone screen;

FIG. 58 is an exemplary representation of the loud panic from FIG. 57, showing a camera flash and a loud audio alarm;

FIG. 59 is an exemplary representation of the complete software application launching after the instant loud panic from FIG. 57 is triggered;

FIG. 60 is an exemplary representation of the active loud panic screen;

FIG. 61 is an exemplary representation of the user's designated emergency contacts receiving a signal activated by the loud panic of FIG. 60; and

FIG. 62 is an exemplary representation of a designated Rescue Center receiving a signal activated by the loud panic of FIG. 60.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

The present invention is a safety/rescue system designed to facilitate the user's survival and rescue from any number of dangerous crises. The present invention may be referenced as the Ultimate Life Protector (ULP). In certain embodiments, the components of the present invention may include a smart phone software application, a panic button that may be a thumb sized bluetooth panic button which sends panic signals to the smart phone application, a server/cloud database, a rescue website, a dedicated 24/7 rescue center and additional optional accessories.

In all cases herein, the following may describe the formula for entering text within the websites, emails, application, and the like, when words are shown in between the following symbols “[ ]”. In such cases, the content may be an unknown variable, and is meant to be automatically inserted when the variable becomes known. For instance, “Hi [EMERGENCY CONTACTS NAME],” In this example, the applicable message recipient's name is automatically inserted within the [ ]. For instance, “Hi Bob Johnson”.

In certain embodiments, the smartphone software application is created in several coding languages required to be compatible with all widely used smart phone operating systems including but not limited to: Android, iOS, Blackberry, Java, Windows, Symbian, Bada, Maemo, Moblin, MeeGo, Palm and webOS. When new smartphone operating systems become widely used, the software code may be translated into the new language, enabling the algorithm of the present invention to function on the new smart phone. Regardless of the operating system, the algorithmic functions of the present invention may be utilized on all suitable smart phones and portable, internet-enabled devices, such as tablets.

The following includes exemplary embodiments of the application of the algorithm of the present invention. After installation, during the first launch of ULP, the user may be prompted to do the following tasks below:

If the user quits the application before entering the required information, when the user re-launches the application, the user may be automatically returned to the signup process described below, and the same continues to happen after application launch until the user enters certain identifying information. For example, the user may enter a unique username, their own contact info, and the contact information for at least one emergency contact who may be invited to participate to help facilitate the user's rescue during an emergency.

The following may include the steps of an exemplary signup process. The user may be prompted to select a unique user name. If the entered user name is already in use, the user may be prompted to create a unique user name. The user name is what makes the user's web link unique. The user may be prompted to enter their own personal contact info, such as but not limited to, their cell phone number, email address, and physical home address. The user may be prompted to take a picture of themselves, so rescuers can know what the user looks like during the rescue. The user may be prompted to enter at least one emergency contact, for example, up to 10 emergency contacts. The emergency contacts may include trustworthy loved ones, campus security if applicable, a doctor if applicable, with phone numbers capable of receiving SMS in addition to email addresses. At the end of this initial sign up process, after all the user's information has been entered, the user may be sent to the test panic screen. A pop up message may inform the user that they must trigger a test panic before gaining the ability to trigger a real panic. If the user quits the application at this time, before a test panic has been triggered, when the user re-launches the ULP application, the user may be returned to the test panic screen. In certain embodiments, until the user triggers a test panic, the user may be brought to the test panic screen each time they launch the application. This may ensure that all users have at least one experience using the present invention, to gain a basic understanding of how it functions before experiencing a true emergency. When the user triggers the very first test panic, all emergency contacts may be sent an email which formally invites them to participate as this user's emergency contact in case of a crisis.

An example of the invitation email may include the following:

### Hi [RECIPIENT'S NAME],

It's [NAME OF USER] here. I'm writing because I just signed up for a safety/rescue service called Ultimate Life Protector™. I need to enter contact info for 10 emergency contacts and I'm hoping you won't mind being one of them.
What I need is very simple. If I launch a panic to indicate that I'm in great danger, my contacts (like you) will receive an SMS text which has a web link. All I need you to do is to call 911 and tell them to go to that link. Simple! The link is http://www.LocateLovedOne.com/[UNIQUE USER NAME]. You can also click the link yourself right on your phone, to see where I am, hear live audio and much more.
Professional rescuers like the police can use this web link to track my location, so they can rescue me. If you have any questions or you don't want to be one of my emergency contacts, please let me know.
Thanks either way!

### [User's Full Name]

[User's phone #]
[user's email address]
Learn more about this safety/rescue service and sign up yourself at http://www.UltimateLifeProtector.com

After the first test panic described above, during which time the emergency contacts may be first invited via email and SMS to participate with the user, the user is able to continue to trigger test panics. Test panic may be located in the more menu of the application. Users may be encouraged to frequently trigger test panics before ever using ULP in a truly dangerous situation. This is encouraged to help users and their emergency contacts to learn all about the various functions and features within the present invention, without contacting the authorities.

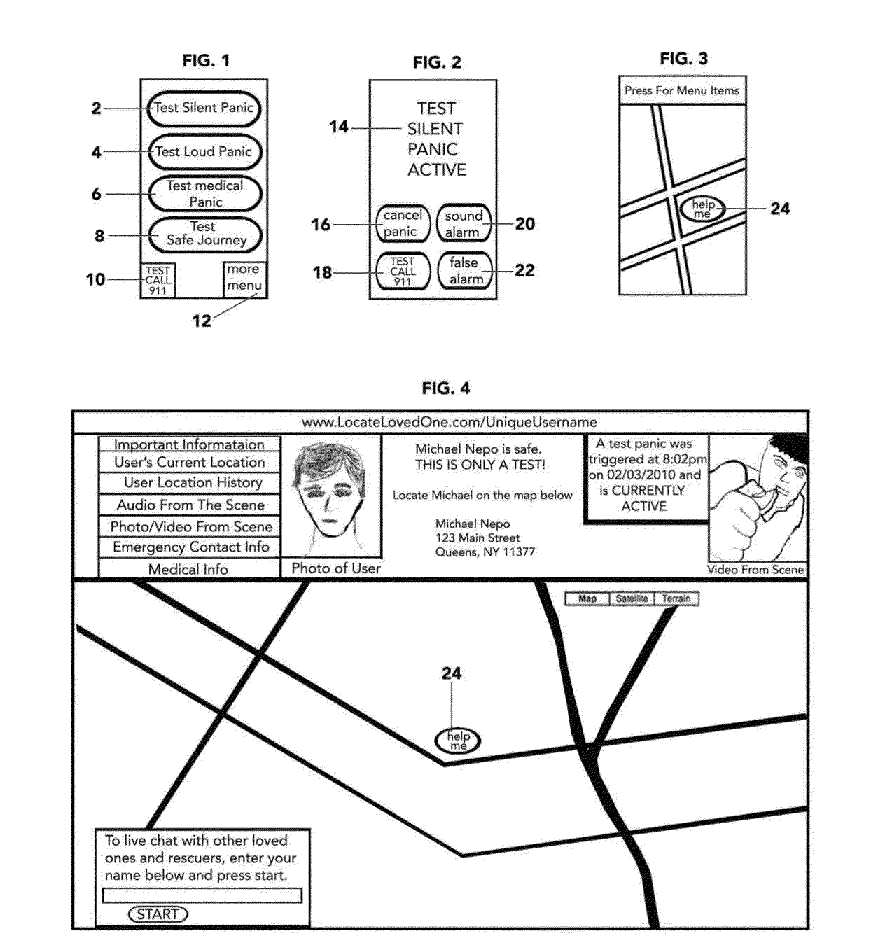

An exemplary embodiment of the test panic screen is illustrated in FIG. 1. In certain embodiments, the test panic screen may contain six main button options, which may include but are not limited to, test silent panic 2, test loud panic 4, test medical panic 6, test safe journey 8, test call 911 10, and more menu 12. If the user triggers a test silent panic 2, the active panic screen 14 illustrated in FIG. 2 may appear, which may display the current panic status, and may contain four main button options, which may include but are not limited to, cancel panic 16, test call 911 18, sound alarm 20, and false alarm 22.

The functions of the test silent panic active screen 14 may act as it normally would during a real panic, except the rescue center is never contacted during a test panic, and during a test panic, the panic SMS and email messages may convey that this is not a real emergency. The test panic may be used to give the user and the emergency contacts experience using the present invention, so they are prepared to assist with a rescue in case of a real emergency. Also, test panic allows the user to confirm that all of the phone numbers and email addresses for emergency contacts are current and correct. Recipients receive test panic messages, at which time they may click directly on the user's web link, with which they can repeatedly visit the website, to fully to understand all the various features available to aid with a rescue. Emergency contacts may click the web link on their web-enabled smart phones, as well as from within email on their desktop, laptop and tablet devices.

In certain embodiments, the user's location may only be shown on the website during active panics, unless the user actively selects an option to share location during non-panics. If the SMS recipient clicks on the web link during the active test panic, the recipient may be taken to the user's personal mobile rescue website, and once the webpage opens, the recipient may view the user's current location, which may be displayed in the form of a blue icon which sits on the map, which may include a message, such as “HELP ME”. The HELP ME icon 24 illustrated in FIG. 3 may represent the present location of the user during a test panic on mobile smart phones. The HELP ME icon 24 illustrated in FIG. 4. represents a larger test panic display for desktop, laptop and tablet devices. In certain embodiments, the user may cancel the active panic and the HELP ME icon may disappear from the website map, hence the website viewer may no longer view the user's current location after the user cancels a panic. However, in certain embodiments, emergency contacts may still be able to view the user's past locations, recorded video, audio, among several other data gathered during the active panic.

An example of the test panic email may include the following:

Subject—“TEST PANIC from [USER'S NAME]

### Hi [EMERGENCY CONTACT'S NAME],

This email is a test panic message from my rescue service called Ultimate Life Protector. If this were a real emergency, I would need for you to immediately call 911 and tell them to locate and rescue me at the following website. You can click on it now to see where I'm located, to hear audio from my position, and to generally learn what the website can offer in case of a real emergency.

http://www.LocateLovedOne.com/[UNIQUE USER NAME]

In a real emergency, I need for you to call 911 if you ever get this panic message from me. Just tell 911 the web address above, and they'll be able to rescue me. In a real emergency, when you call me to confirm, you can ask me for my password. It is [INSERT PASSWORD] If I don't tell you the correct password, it means that I am under duress.

Thank you for agreeing to help me if danger!
[User's full name]
[User's phone number]
[User's email address]

In certain embodiments, when the user first installs and signs up for the present invention, the default mode for the rescue center may be disarmed. In such embodiments, the user may actively arm the present invention by pressing the “ARM” button within the application. A pop up screen may appear which may convey that the present invention is armed, such as, “Warning! When rescue center is armed, the authorities will be notified when a panic is triggered, so arm rescue center with caution. Once armed, the rescue center will remain armed until you disarm it.” When the present invention is armed, the application may display “Rescue Center is currently ARMED” which may be at the top of the application screen. If the rescue center is disarmed, the application may display, “Rescue Center is currently DISARMED” which may be at the top of the application screen.

As mentioned above, after arming the rescue center, the user may read the warning pop up message. In certain embodiments, the users may select either: “Arm Rescue Center” or “Cancel”. If the user chooses to arm the rescue center, the user may be prompted to enter their correct password. After the correct password is entered, the ULP rescue center may be armed. In certain embodiments, the program may remain armed every time the user uses the present invention, until the user actively disarms it. Even when the user quits the application of the present invention and turns off the phone, when the phone is powered on, and a panic is triggered, the previous armed or disarmed setting may remain in effect until the user changes the setting.

Disarm mode may be intended for many uses beyond as a tutorial device. In certain embodiments, the user may use the present invention for non-emergency situations. For example, the user may select a “Non-Emergency” button which may be available in the menu items. When this mode is selected by the user and the user then triggers any panic mode, emergency contacts may receive SMS and email messages which may state that the panic is not life threatening, but the user does request their assistance. If users choose to use a panic in a non-emergency mode, before triggering a panic, users may be encouraged to notify the emergency contacts that the user is not facing a real crisis via a pop up screen which appears after the user presses the “non-emergency button”. The pop up screen may read, “If you intend to trigger a panic during a non-emergency, you are strongly encouraged to send a warning message to all contacts.” The two button options which appear underneath the pop up screen may read, “Send Warning” and “Cancel”. If the user selects “Cancel”, a new pop up screen appears which may read, “Non-Emergency Mode cancelled. All panics will be treated as real emergencies.” If the user selects, “Send Warning”, SMS and email messages may be sent to all emergency contacts, which may state that the user is currently safe, but intends to trigger a non-emergency panic. The contact's help might be requested by the user, but not for a life-threatening emergency.

In certain embodiments, disarm mode may be used to give adults the ability to constantly monitor their young children in a variety of intuitive and useful ways, in non-life threatening situations, e.g., walking with a young child at an outdoor festival. For example, the parent may enable location sharing during non-panics on the children's ULP devices before entering an outdoor festival, shopping mall, or any number of other large places, where the guardian is concerned that they might lose sight of the children. With location sharing during non-panics active, the parents and children can walk around the large space confidently, because if they suddenly lose sight of their children, they simply awaken their smart phones, and instantly see exactly where the child or children are located on a map, in addition to various other vital data. Such embodiments, may be used with children or individuals suffering from mental illnesses such as dementia or other mental issues which call for constant monitoring. However, in most embodiments of the present invention, it is the user who controls whether or not their location and audio/video are being monitored.

In certain embodiments, the disarm mode may be used with teen age children during non-life-threatening situations, such as an unchaperoned teen age party, for instance. In these cases, the user can double-press their designated panic trigger button if the user wishes to inform other friends who are present at the party that they are uncomfortable with a situation, perhaps involving an intoxicated, aggressive male classmate. The user may retain the power to determine whether or not they trigger a panic. Since the panic message recipients may be at the very same party or event, the friends may instantly rescue the user who may be in another room. If the user chooses, she can include her parents on the list of panic recipients. If a panic has been triggered, the parents may be able to listen to the audio and/or view video from the situation and determine their next course of action.

In certain embodiments, the disarm mode may be used for a user who has no crisis whatsoever, but merely wishes to notify their nearby friend or associate that they are uncomfortable in a situation. For instance, one user might bring two friends to a social gathering. The user might wish to be “rescued” from the awkward conversation they are engaged in, or perhaps a celebrity discreetly triggers a disarmed panic to notify her publicist that she wants to stop giving an interview. In other words, in this case, the user wants the publicist to “rescue” her from the interview. Therefore, after the user has disarmed the rescue center, and notified her Emergency Contacts that she is planning to use ULP in a non-threatening situation, by using the non-dangerous warning feature described above, the user may double press a discreet button to be “rescued” from any socially delicate situation.

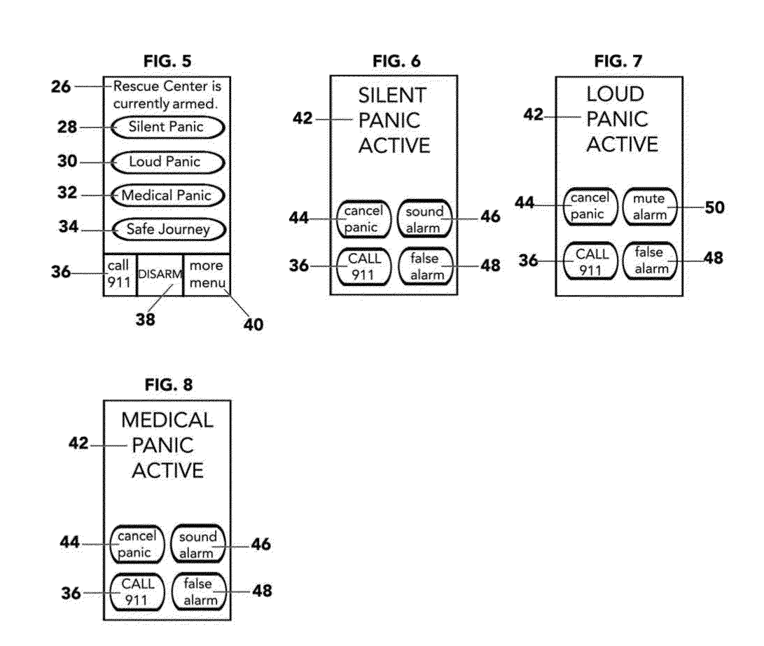

In certain embodiments, the disarm mode may be used for first dates with a new acquaintance. Users might wish to have their close friends available, prepared to receive the ULP SMS if the user becomes uncomfortable with their situation, even if they don't necessarily initially perceive the situation to be physically dangerous. The friend receives the message and immediately hears audio, possibly live video, and the user's location. The message recipient may both call the user, and go to the user's location. In such a situation, where the user might originally have believed that there was no physical danger, but the panic message recipient listens to the ULP audio stream, and/or views the user's video stream, and believes that the user might be in actual physical danger, the message recipient simply calls the nearest professional rescue precinct shown on the rescue website, and tells the rescuers the user's unique web link. The nearby public rescuers may use the link to locate and rescue the user, while gathering all the timely data described herein. In other words, even if the user disarmed the rescue center, if emergency contacts/panic message recipients listen to the user's audio, and view the user's video, and these cause the emergency contacts to believe that the user faces a truly dangerous crisis, they may instantly contact professional rescuers, and by providing public rescuers with the user's web link, the rescuers treat the emergency as if the user intended for the rescue center to be armed. FIG. 5 illustrates the home screen of the present invention's application. At the top of the screen, the home screen may display whether or not the rescue center is armed or disarmed 26. In this example, it reads, “Rescue Center is currently ARMED” 26. Directly underneath the arming status, the silent panic button 28 may be displayed. When the user selects the silent panic button 28, a silent panic mode is triggered. The present invention may further include a loud panic button 30, a medical panic button 32, and a safe journey button 34 displayed on the application home screen.

In certain embodiments, there may be a call 911 button 36. When the user presses this button, the user may have instant access to the outgoing phone call screen of the user's phone with 911 pre-dialed. In certain embodiments, 911 may be dialed with two taps of the screen. The first tap may be to select the call 911 button 36, and the second tap may to select the call button on the standard phone outgoing call screen. The user may arm or disarm the present invention by selecting the arm or disarm button 38. In certain embodiments, the user may select the more menu button 40 to view various available options as described below.

In certain embodiments, there may be multiple panic modes within the application of the present invention. As mentioned above, there may be a silent panic, a loud panic, and a medical panic. FIG. 6 illustrates the silent panic active screen 42, which may be accessed by selecting the silent panic button 28 on the application home screen. The status and type of the panic may be displayed in the upper half of the application screen. The user may cancel the active panic by selecting the cancel panic button 44. The silent panic active screen 42 may further include a sound alarm button 46, a call 911 button 36, and a false alarm button 48. In certain embodiments, prior to canceling any “real” panic, i.e. non-test panic, the user may have to enter their correct password for safety precautions.

The loud panic active screen 42 is illustrated in FIG. 7. The button options may be similar to the silent panic active screen 42, however the alarm may sound automatically when the loud panic button 30 is triggered. In certain embodiments, the loud panic active screen 42 may further include a mute alarm button 50. When the user selects the mute alarm button 50, the alarm may be silenced.

FIG. 8 illustrates the medical panic active screen 42. This screen 42 may include the same button options as the silent panic active screen 42 from FIG. 6. However, the color, text and graphics on the medical panic screen 42 may be different from the silent panic screen, which may be different from the silent panic screen 42 to easily distinguish them from each other. Further, the panic status may read medical panic active 42.

In certain embodiments, when the panic modes are activated, the user's location may be pinpointed and the map position may be sent immediately to the server/website. SMS and email messages may be sent to the user's emergency contacts, which may include campus security if applicable, as illustrated in FIG. 13, and the designated ULP rescue center as illustrated in FIG. 14, if the application of the present invention is in the armed mode. If the user has no cell phone signal when the panic is triggered, repeated automatic attempts to send the panic messages and other data may be made until adequate cell tower or WIFI signal becomes available. Within the SMS and email, a clickable web link may be displayed with the user's own unique web address configured, using the user's unique username within the URL. Rescuers may click the link on their smart phones to view the mobile website as well as a desktop website such as for rescue dispatchers. In certain embodiments, the URL format may be simple and easily shared verbally on the phone with professional rescuers. In certain embodiments, audio and video may begin to stream from the user, directly to the server/website for rescuers to hear and see in near real time. A photo may be taken at the moment the panic is triggered and may be uploaded to the server/website.

In certain embodiments, on the application panic screens, buttons are available which read, “Take New Photo”, “Stop Video” and/or “Start Video. When pressed, new photos and/or video may be taken, and then sent to the website, and in the case of “Stop Video” the video stops recording and transmitting. In addition to these buttons, photos and/or video may be automatically captured and transmitted during typical use after a panic has been triggered, because the default setting may be such that video and/or photo are automatically captured and transmitted during any panic, without requiring that these screen buttons are selected. The user may have the option to disable the default video recording during panics in the application preferences, for instance, if the user's location is such that their phone signal is expected to be too weak to successfully carry the data-heavy video transmission. In such cases, the user may select the “Low Resolution Video” option within the application preferences, so that the default setting mandates that video may be recorded during all panics, with highly compressed, lower resolution, to minimize the amount of data that must be transmitted during a panic, to thusly maximize the successful transmission of the user's panic messages, location and audio. The user may also choose to select the “Automatically adjusting video resolution” option within the application settings. With this feature selected, the video may be set to always record and transmit during a panic, and the resolution of the video may be automatically determined by the user's available bandwidth and cell phone signal, with the video transmitting automatically at a lower resolution when the limited available bandwidth requires a smaller data size to be transmitted. The default setting may be such that, during an active panic, if the cell phone signal becomes significantly reduced, the first data to automatically cease transmission may be video. In such cases, video may continue to record on the user's phone if local memory is available, where it is stored until stronger bandwidth allows for the video transmission to the website to take place. If the available bandwidth has been reduced to such an extent where the audio recording is providing too much data transmission, as with the video, the audio may automatically continue to record on the user's local smart phone, to be transmitted to the website when enough bandwidth becomes available to the user. In other words, when available bandwidth becomes limited, video is the first data to be restricted, and after video, audio is the second data stream to be restricted. Therefore, the present invention may prioritize the sending of the panic messages, and the ascertainment and transmission of the user's current and previous location, above all other data-heavy functions. In such a low-bandwidth situation where video and audio are restricted, a still photograph may be taken and transmitted to the website.

In certain embodiments, the present invention may include accessories that may be utilized. For example, the user may have a designated ear or head mounted video accessory 54, in which live video from the user's vantage point may stream to the website for rescuers to view. In certain embodiments, the user may have a pulse monitor accessory, and in such cases the user's pulse rate may be displayed on the website. In such embodiments, a dangerously abnormal pulse reading may automatically trigger a Medical panic. In certain embodiments, the user may have a breathing monitor, and thereby the status of the user's breathing is shown on the website. In such embodiments, dangerous breathing levels may automatically trigger a medical panic. In certain embodiments, a user may have a brainwave monitor, such as a flexible cap which may be densely packed with electrodes. In such embodiments, potential brain related issues such as a seizure, stroke, blunt impact, or other such issues are displayed on the website. Serious brain related issues detected by the brainwave monitor may automatically trigger a medical panic. In certain embodiments, the present invention may further include automatically activated electrical cardiac resuscitation pads. In such embodiments, when the user experiences sudden cardiac arrest, the sensors recognize this, and the pads administer the correct amount of electrical impulse to defibrillate the user's heart. A medical panic may be triggered. The process may automatically cease as soon as the sensors determine that a safe heart rate has been restored. The user's heart may be monitored on the main home screen of the rescue website automatically, as soon as the irregular heart-related issue is discovered by the heart sensor; pads.

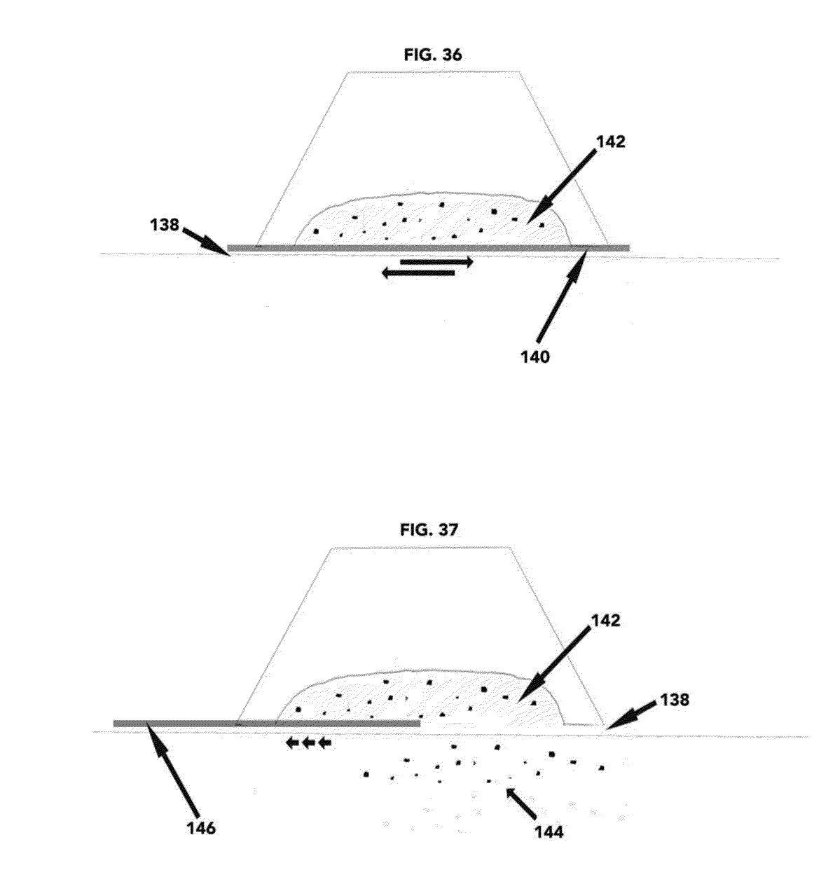

In certain embodiments, the present invention may further include a transdermal medicine distribution patch, illustrated in FIGS. 36 and 37. When a user (in consultation with her doctor) determines that essential medicine should be administered at particular times each day, the medicine may automatically administer according to a predetermined schedule. Medicine may also be withheld until designated nano-blood probes determine that the user is facing a potentially deadly crisis such as a bee sting for users who are allergic to bee stings. In a case such as an allergic user suffering a bee sting, the medicine distribution patch may release epinephrine automatically after the probes determine that it is medically necessary. A medical panic may be triggered when the probes determine that this crisis has begun.

In certain embodiments, the silent panic mode, the bud panic mode and the medical panic mode may include the following differences. When the silent panic mode is triggered, no camera flash may appear, and the phone may remain silent unless the user selects the sound the alarm button 46 on the application screen. If the user selects the sound the alarm button 46, a pop up message may appear to warn the user such as, “Are you sure? It will be loud.” The user may select cancel and no alarm may be sounded. If the user confirms the sound alarm, the alarm may be sounded. The user may silence the alarm by selecting mute alarm button 50 on the application screen. When silent panic is triggered, the user's phone ringer may switch to a vibrate mode. When the bud panic is triggered, the camera may flash brightly, and a bud noise may play such as a police siren, from the phone's speaker. A voice may also repeatedly play declaring that “Your pictures have been sent to the authorities.” The user may silence the alarm by selecting the mute alarm button 50 on the application screen.

When the medical panic is triggered, in certain embodiments, no camera may flash and no noise may be made unless the user selects the sound alarm button 46. If the user selects the sound alarm button 46, audio from the phone's speaker may play such as a loud voice repeatedly declaring, “Help me! I'm having a medical emergency!”

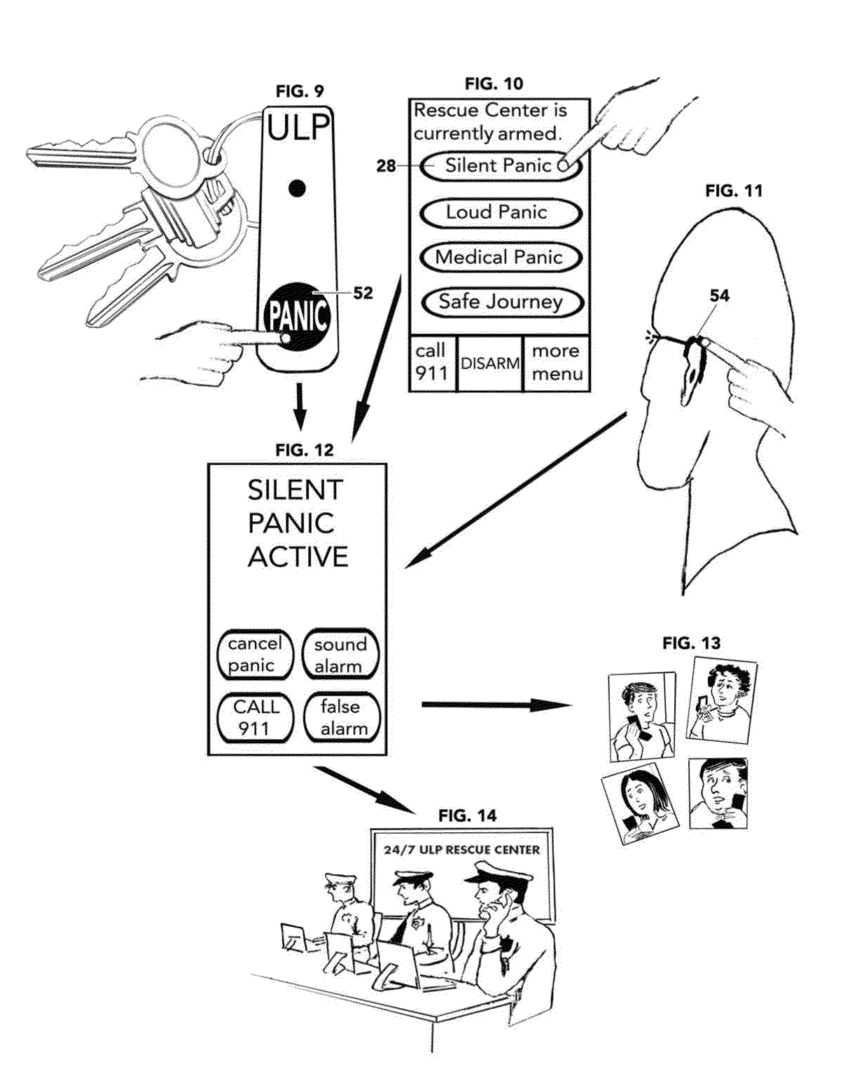

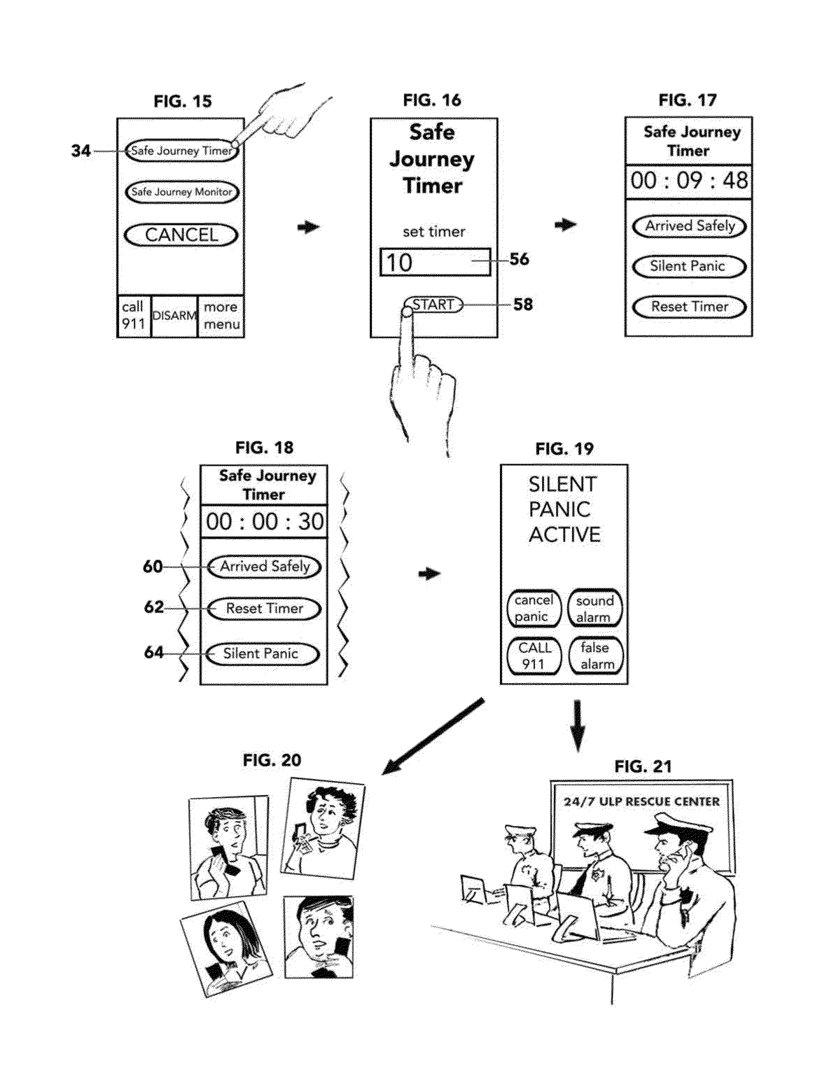

In certain embodiments, the silent panic may be triggered manually. Silent panic may be the default panic mode. In certain embodiments, the silent panic may be triggered when the user double dicks a physical Bluetooth®-enabled panic trigger button 52 as shown in FIG. 9, may be triggered if the user double dicks the panic button on the ear/head-mounted video camera 54 as represented in FIG. 11, may be triggered if the user double clicks any other designated physical panic trigger, may be triggered if the user selects the silent panic button 28 from within the ULP application as illustrated in FIG. 10, may be triggered automatically during an active safe journey monitor if the user stops moving towards their designated destination as illustrated in FIG. 30, FIG. 40, FIG. 41, FIG. 42 and FIG. 43, may be triggered automatically when extreme g-forces are detected which could be consistent with a car accident or other potentially injurious event as illustrated in FIG. 44, or may be triggered as a scheduled panic via the safe journey timer described below and illustrated in FIGS. 15 through 21. The user's phone may make no sound when Silent Panic is triggered, and no camera flash may be seen. When Silent Panic is triggered, the user's phone ringer automatically switches to vibrate mode, to prevent unwanted attention directed to the user if the panic message recipients attempt to call or send SMS to the user. If the user chooses, they may select the sound alarm button 46 from the active panic screen as illustrated in FIG. 6, if the user wishes to deter an attacker with sound of a police siren that may be coupled with a voice declaring, “Your pictures have been sent to the authorities.” When the user first selects the sound alarm button 46, a pop up screen may warn the user that it will be loud. If the user confirms, the alarm may sound. This pop up warning may appear in order to prevent the user from accidentally sounding the alarm, for instance, if the user is hiding from an attacker. The user can mute the alarm by selecting the mute alarm button 50. The same button may toggle between the sound alarm button 46 and the mute alarm button 50, presenting the alternate option of the mode which is currently in effect.

In certain embodiments, when the user triggers a loud panic 30, either by selecting it from the ULP application as shown in FIG. 5 or by choosing for loud panic to be the default panic mode in the general preferences, in certain embodiments when one of the physical panic trigger devices is double pressed, all the sequential actions described above may take place. In addition to those above actions which may take place when a silent panic is triggered, when a loud panic is triggered, the phone's camera flash may shine brightly, the audio sound which simulates the taking of a photograph with a traditional physical camera may be played through the phone's sound speaker, and finally, a recording of an authentic American police siren may play through the phone's sound speaker, along with a loud voice which repeatedly may declare, “your pictures have been sent to the authorities”. This may be meant to deter a potential date rapist, or other possible assailant whom the user believes might be deterred by this camera flash and recorded warning. In such situations, the user may be advised to tell the attacker that his picture has been sent to the authorities, so he should not proceed with his illegal behavior if he wishes to avoid punishment.

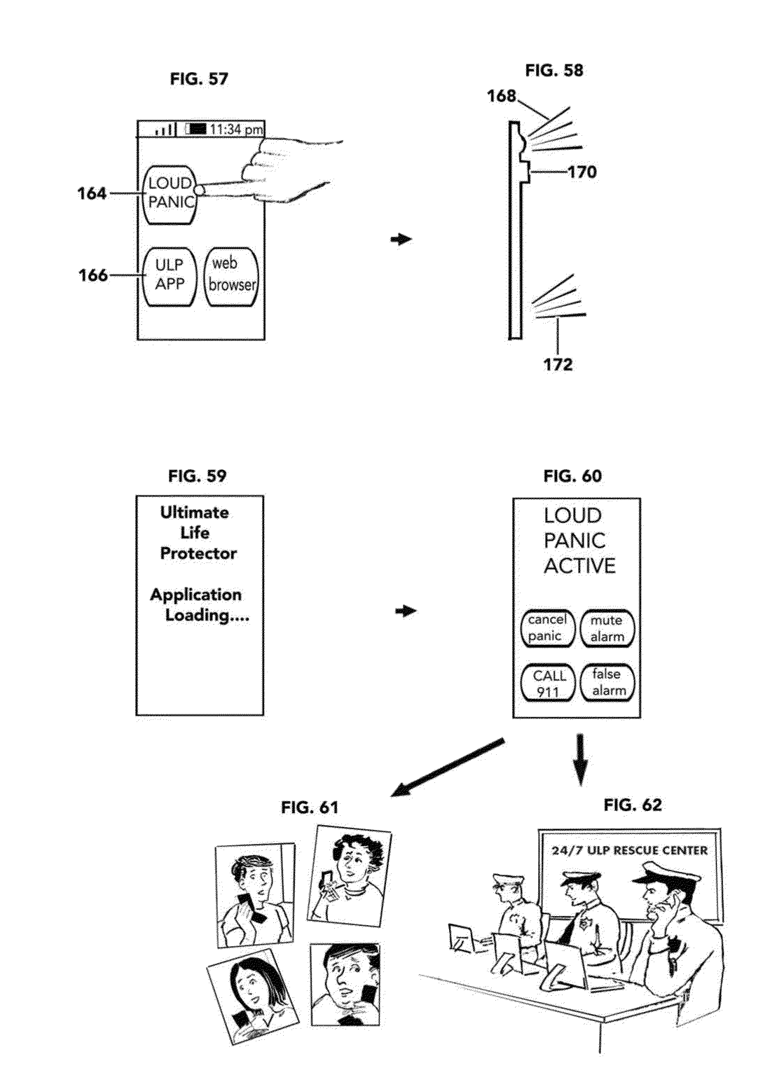

The user may have the option, within the smartphone application, to place a loud panic button icon 164 directly onto the home screen of the user's smartphone, as shown in FIG. 57. This onscreen loud panic icon 164 may be distinct and separate from the onscreen icon which may be selected by the user to launch the main ULP application. This loud panic icon 164 may visibly be easily recognized by the user as the loud panic, visually different from the ULP application icon.

When the user selects this loud panic button icon 164 which may reside on the home screen of the user's smartphone, the smartphone may immediately display a bright camera flash 168 as shown in the side view of the phone in FIG. 58, a sound 172 which simulates the sound of a physical camera taking a picture from the phone's speaker as shown with simulated audio lines, a loud and authentic recording of an American police siren which may be repeatedly played, and a loud voice may repeatedly declare a statement such as, “Your pictures have been sent to the authorities. After the previous actions take place, the main ULP application may be fully launched as shown in FIG. 59, and any audio, photos, video, location data or other data captured by the user's phone at the instant when the user selected the onscreen loud panic icon 164 may be transmitted to the rescue website, and all previously described functions which take place when loud panic is triggered may be executed.

With the onscreen loud panic icon 164 present on the home screen of the user's smartphone, users may be able to rapidly deploy the loud panic as an instantly available deterrent against a potential attacker, without any requirement for the user to launch the main application first. In such a case where a user believes that an attack is imminent, the user may be able to trigger the onscreen loud panic in order to deter a potential attacker more quickly than if the user were to be required to launch the main application first. In such a case, it may be essential for the user to display the bright camera flash and other functions from loud panic immediately after selecting the onscreen icon, so the onscreen loud panic icon 164 may allow the user faster access to the loud panic trigger than if the user were to be required to launch the main application first, because it may take several seconds for the main application to launch, and then to trigger bud panic from within the main application.

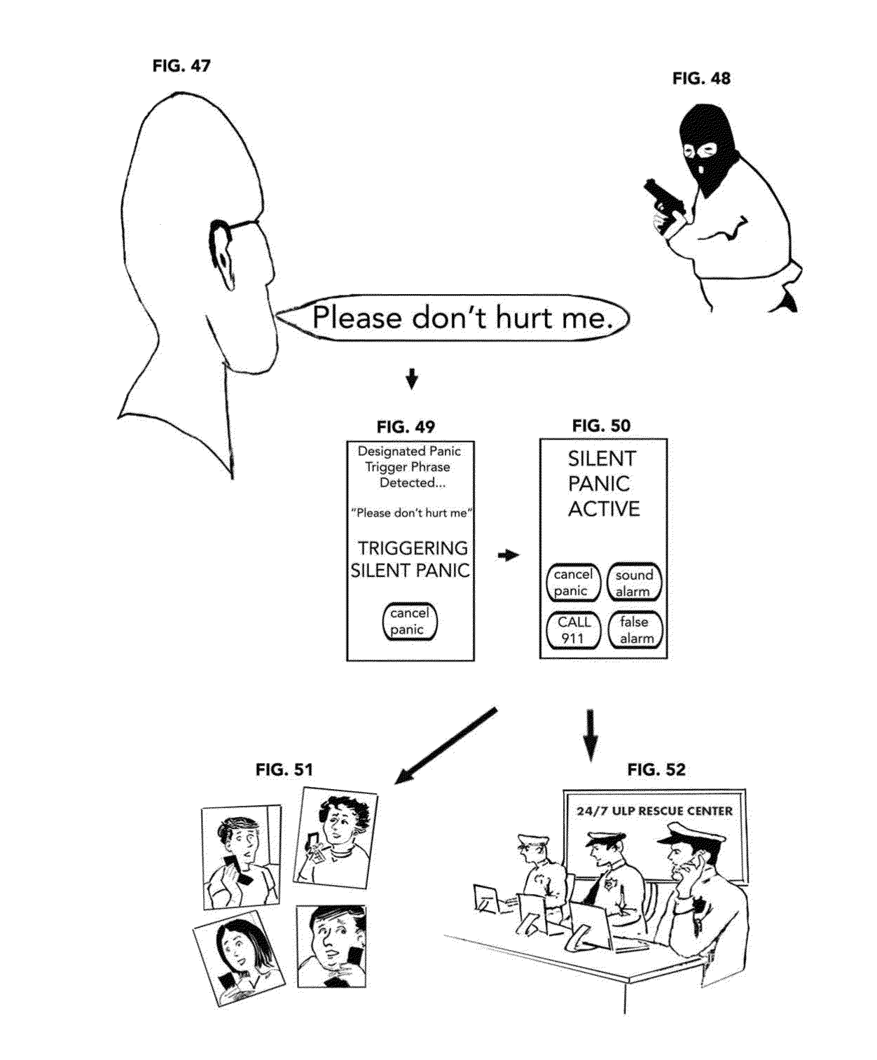

The user may have the option, within the smartphone application, to designate specific verbal phrases which, when spoken aloud by the user, the speaking of these designated phrases may cause specific panic modes to be triggered. For instance, if the user were to designate the phrase “Please don't hurt me” as a trigger phrase, when the user speaks this phrase as illustrated in FIG. 47, via voice recognition software present within the application as illustrated in FIG. 49, a silent panic may automatically be triggered as illustrated in FIG. 50 which notifies and shares all data with emergency contacts as illustrated in FIG. 51 and the rescue center as illustrated in FIG. 52. When this panic is successfully triggered, pulse vibrations may take place on the user's phone and all related accessories to the ULP system such as the Bluetooth®-connected panic trigger button, and/or the ear mounted audio/video camera. These vibrations may serve to notify the user that their designated spoken phrase has successfully triggered a silent panic discreetly, without notifying a potential attacker.

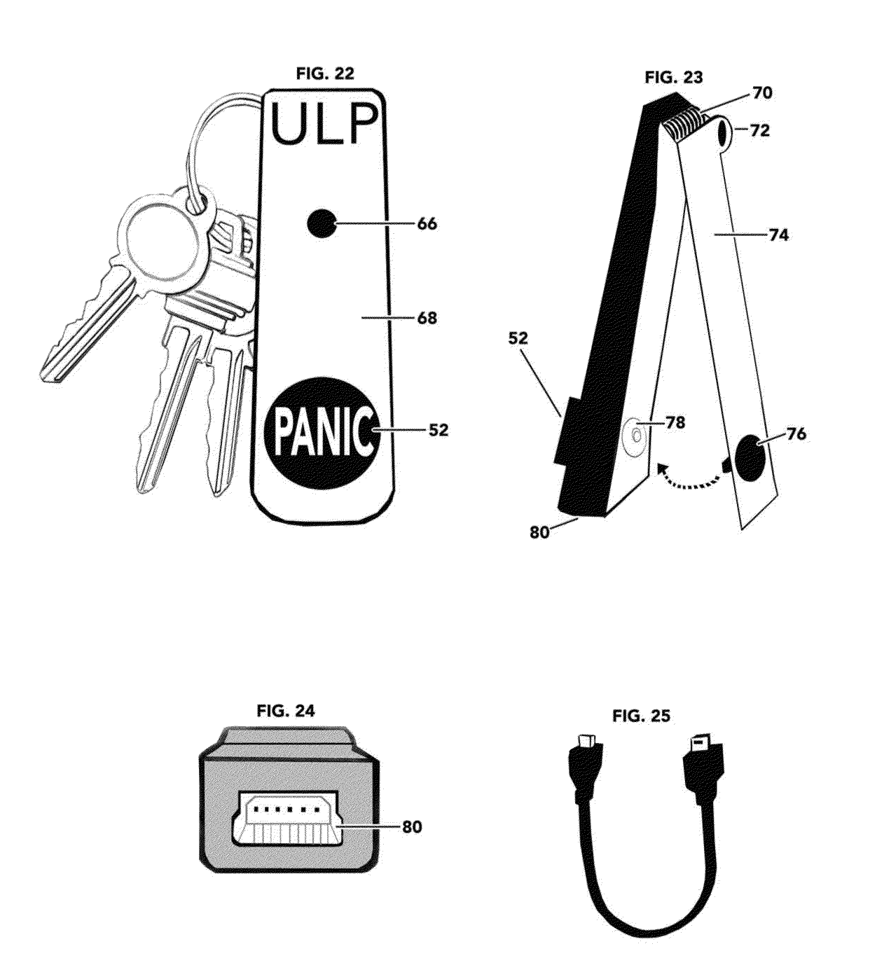

In certain embodiments, the user may trigger a medical panic in seven ways: Firstly, by selecting the medical panic button 32 in the application screen as illustrated in FIG. 5, second, by choosing for medical panic to be the default panic in the general preferences, in which case the medical panic made may be triggered when the user double dicks any of the physical panic trigger devices such as the thumb sized button 66 as illustrated in FIG. 22, thirdly, if a designated medical verbal phrase such as “I'm having chest pains” is spoken, it is detected by the voice recognition within the smartphone, fourthly, if general preferences are set to default to medical panic when the safe journey timer reaches zero, fifthly, if general preferences are set to default to medical panic when the safe journey monitor detects a problem, sixthly, when the g-force monitor detects a problem, medical panic may be triggered, and seventh, when one of the optional medical accessories such as pulse monitor or brainwave monitor detects a medical problem.

As with all panic modes, the sequential actions described for the silent panic mode may occur, and in addition to those sequential actions, the SMS and email messages, along with the rescue website, may notify the rescuers that this is a medical emergency. If the user has certain preexisting medical conditions, rescuers may learn this key information on the website in the user's medical info section. If the user purchased any of the optional medical accessories listed above, the rescuers can do any of the following on the user's rescue website: monitor the user's pulse rate; monitor the user's breathing; monitor the user's key blood levels; monitor the user's brainwaves for possible seizures, stroke, blunt impact, or other electrode-detectable brain issues; determine the amount and timing of, and monitor the automatic administering of vital medicine; and monitor the activity of the automatically activated electrical cardiac resuscitation pads. With medical panic, the user may not be required to speak for assistance to be summoned. For instance, if a user is having an asthma attack which makes it impossible for them to speak, the user may simply press the medical panic button 32 and an ambulance may be set en route to rescue the user within seconds after pressing the button 32. There may be no need to speak or remain conscious once the panic has been triggered. If the user has a serious recurring medical condition such as asthma, the user may be able to create a unique screen button of their choice, to reside on the medical panic screen. This may be offered in the general preferences. The user may press this button to trigger the medical panic, as an additional signal to rescuers. For example, the asthma sufferer creates an “asthma attack” button. If the user is unable to speak, she can press that button, instantly notifying rescuers of the nature of the emergency, without speaking. The user can create several different buttons for potential health crises which might be relevant to a particular user such as heart attack, stroke, asthma and the like. In certain embodiments, if the user selects the sound alarm button 46 as illustrated in FIG. 8, a loud voice repeatedly declares, “Help me! I'm having a medical emergency!”

In certain embodiments, the application of the present invention may further include a safe journey timer, which may set off an automatic panic trigger. When the user begins any journey, they may activate the safe journey timer mode by pressing the safe journey timer button 34 as illustrated in FIG. 15. The user may then set the timer for the estimated time the journey will take. If it normally takes 10 minutes for a student to walk home from the library, for instance, the user may set the timer 56 for ten minutes as illustrated in FIG. 16, select the start button 58 and then the user may put the phone back in their pocket while the timer counts down, as illustrated in FIG. 17. When the timer reaches the final 30 seconds of the countdown, the smart phone may begin to pulse vibrate for each of the remaining 30 seconds of the countdown as illustrated in FIG. 18. This may be done to warn the user that the countdown is almost finished. If the user is safe, when the vibrations begin, the user may select the arrived safely button 60 to cancel the countdown, or the user may select the reset timer button 62, as illustrated in FIG. 18. If, during the countdown, the user is conscious and suddenly discovers that they are facing a crisis, they may instantly trigger a silent panic by double pressing a physical panic trigger device 52 as illustrated in FIG. 22. In certain embodiments, the users may double press the panic button on the ear mounted video camera 54 as illustrated in FIG. 11 and the user may also trigger a panic by selecting the silent panic button 64 from the safe journey timer screen during the countdown, as illustrated in FIG. 18. If the user is unconscious or otherwise incapacitated, when the timer reaches zero, the silent panic mode may automatically trigger as illustrated in FIG. 19, and the rescuers may be alerted with SMS and email as illustrated in FIG. 20 and FIG. 21. As with other panic triggering, the sequential actions of the silent panic mode may be executed when the safe journey timer countdown reaches zero. Additional optional accessories mentioned herein may also contain physical panic buttons which the user can double-press to manually trigger a panic at any time, including during the safe journey timer countdown.

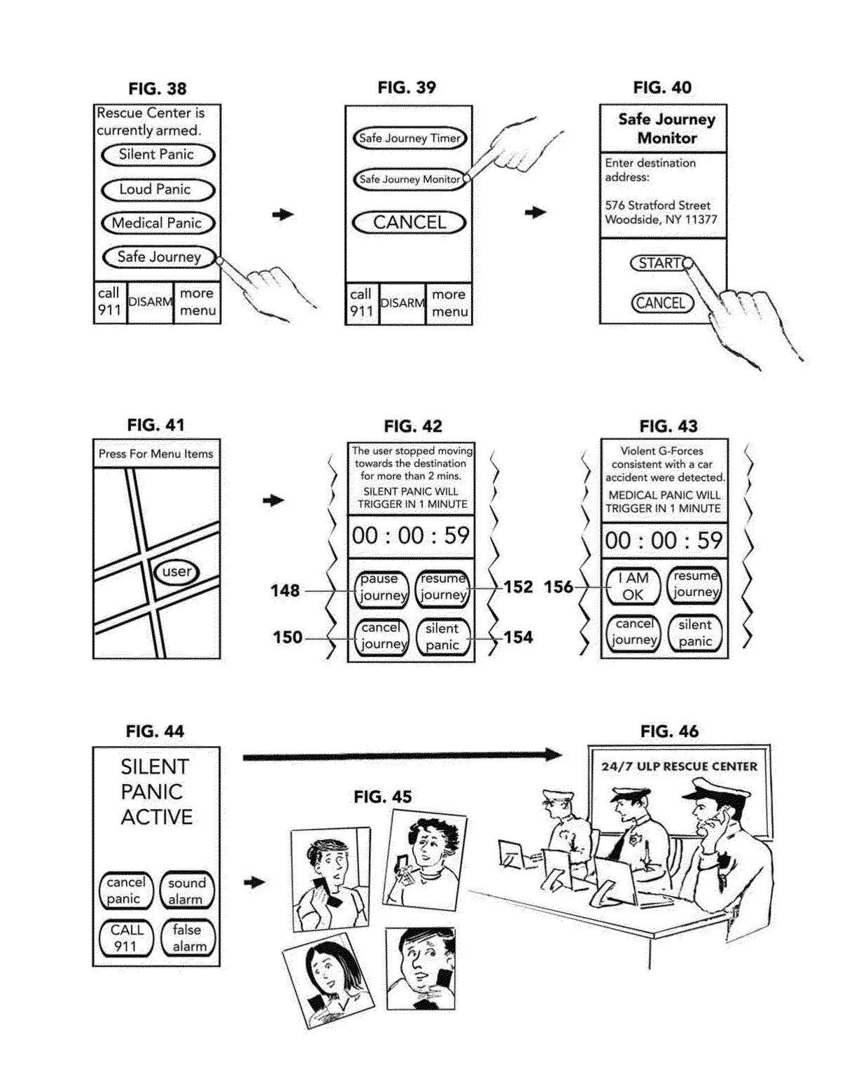

Before the user embarks on any journey, the user may select the safe journey monitor from the application, as illustrated in FIG. 38 and FIG. 39, and enter the address, location on a map, and/or latitude/longitude coordinates, of their intended destination in the safe journey monitor within the application, as illustrated in FIG. 40. After the user activates the safe journey monitor, the user may begin to travel towards their destination. If the user either deviates away from routes which lead towards the intended destination, or if the user stops moving and stays in the same place for a designated period of time such as two minutes, as illustrated in FIG. 41, the user's smartphone may begin to pulse vibrate for a designated period of time such as one minute, as illustrated in FIG. 42. These vibrations may be meant as a warning to the user that the safe journey monitor will trigger a silent panic soon, because the user has stopped progressing towards their designated destination. If the user is safe and has stopped moving towards their designated destination for a reason not associated with a crisis, for instance if the user is stuck in gridlocked traffic, when the user notices the vibrating smartphone, the user may pause the safe journey monitor until they are ready to proceed with the remainder of their journey, as shown in FIG. 42, example 148. When the user is ready to continue with their journey, they may be able to re-activate the safe journey monitor by selecting the resume journey button as shown in FIG. 42, example 152. If the user wishes to cancel the safe journey monitor, they may press a button labeled cancel journey 150. If the user wishes to trigger a silent panic, they may press the silent panic button 154. The speed of the user's movement during the journey may be tracked and presented on the website. If the user successfully reaches their designated destination, the user may have the option of automatically messaging the emergency contacts upon the user's arrival at their designated destination, to notify the contacts that the user has safely arrived at their designated destination.

In cases where the user has stopped progressing towards their designated destination while the safe journey monitor is active, after the designated vibration period has expired, if the user does not intervene, silent panic may be automatically triggered, as illustrated in FIGS. 44 through 46. In cases such as car accidents, where the user may become unconscious or otherwise unable to access their phone, the automatic silent panic triggered by the safe journey monitor may inform all emergency contacts and rescuers that the user has failed to complete their journey, while providing the rescuers with the previously described vital data needed to rescue the user.

As illustrated in FIG. 43, in cases when the smartphone observes a sudden and extreme variation of g-forces on the phone, such as g-forces consistent with a moving car crashing into a tree for instance, the predetermined extreme g-force variation, when observed by the phone, may cause the phone to begin to vibrate for one minute. At the end of that minute, medical panic may be automatically triggered. If, during the minute of vibrations, the user selects the button labeled I am OK 156, as shown in FIG. 43, the safe journey monitor may be paused and no panic may be triggered. If the user takes no action after the phone begins to vibrate, at the end of the minute, medical panic may be automatically triggered.

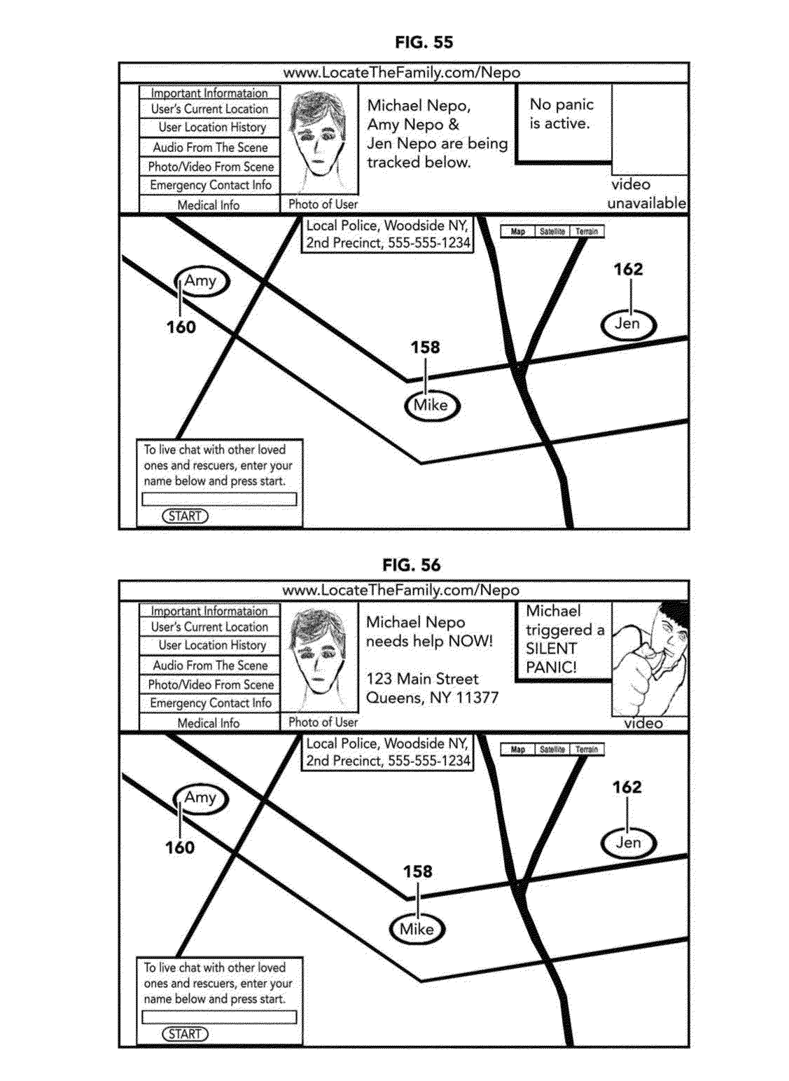

In cases where the user chooses to provide the emergency contacts with updates as to the user's location and speed of travel during the journey, regardless of whether or not the user has stopped progressing towards their designated destination, and regardless of whether or not a panic has been triggered, the user may be able to activate a function with which the user chooses to share their location data with the emergency contacts by transmitting the user's location data to the website at regular, designated intervals such as every 30 seconds, without any active panic. In such cases where the user may have chosen to transmit their location data to the rescue website during their journey, users may notify emergency contacts such as parents that they may have the ability to monitor and observe the user's location data on the rescue website as the user travels towards their designated destination, even when no panic mode is active, as illustrated in FIG. 55, examples 158, 160 and 162. If the user does not choose to activate location data sharing during non-panics, it may not be possible for emergency contacts to view the user's location data unless a panic is triggered, and/or if the user chooses to activate the location data sharing option during non-panics.

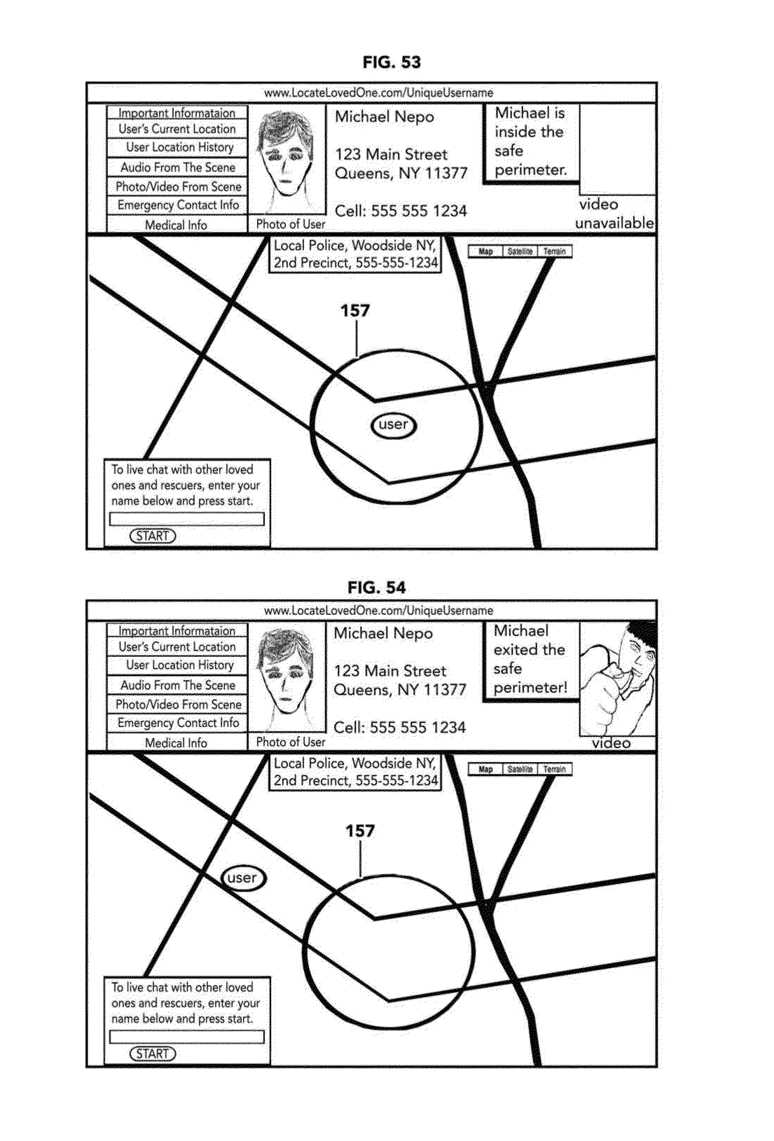

The user may have the option, within the smartphone application, to designate a specified area considered to be a safe zone by the user and the user's emergency contacts. The user may have the ability to set and reset the size and shape of the borders of this safe zone, to form the perimeter of a designated safe area 157 as illustrated in FIG. 53. While the perimeter monitor is active, if the user remains within the designated safe perimeter as illustrated in FIG. 53, no panic may be triggered. If the user crosses the border of the perimeter, exiting the designated safe perimeter as illustrated in FIG. 54, a perimeter breach panic may be triggered, and the rescue website displays a large text statement which informs all rescuers that the user has exited the safe perimeter. Users can determine whether or not the perimeter breach results in contacting the ULP rescue center. For instance, in most cases, a user simply exiting the safe perimeter does not suggest that the user is in mortal danger. For this reason, the default mode may be for the emergency contacts to receive messages when the user breaches the safe perimeter. In other cases, such as a user with severe dementia, the settings may be selected so that the ULP rescue center as well as emergency contacts are notified of the safe perimeter breach.

In cases when a user is currently outside the safe perimeter, the user may designate the safe perimeter as the designated destination. When the user arrives at the designated destination, if the user chooses, they may select an option which enables all emergency contacts to automatically receive messages such as SMS and email notifying the emergency contacts when the user has arrived at their designated safe destination.

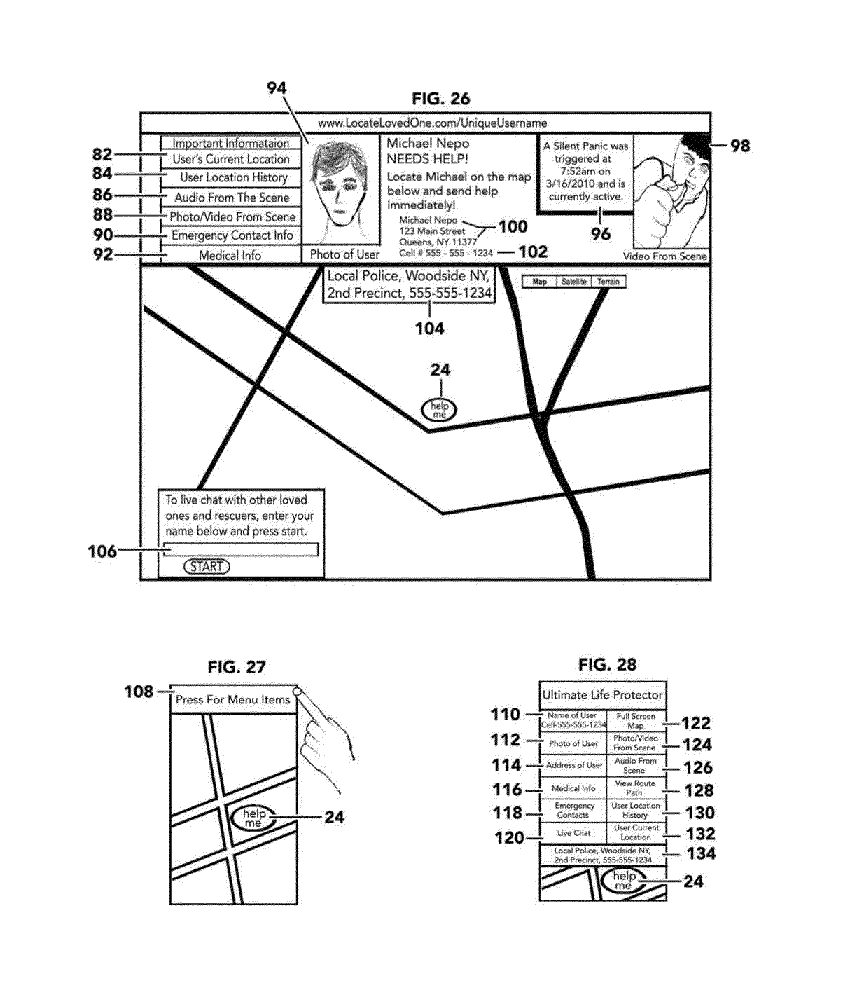

In certain embodiments of the present invention, a family mode may be incorporated. Multiple users of the present invention may have the ability to designate themselves as members of a single family unit. Each family member may possess their own unique username. If each user within the family has enabled the location data sharing during non-panics, all the participating users' location data may be transmitted to two distinct websites; a) The user's primary website with a unique URL such as www.LocateLovedOne.com/[USERMAME] as illustrated in FIG. 26, and b) www.LocateTheFamily.com/[The shared family name] as illustrated in FIG. 56.

When the family initially enters their family name, if this name has already been entered into ULP by a different family, it may not be possible for the user to register this name. A unique family username may be required. For instance, “Smith77” may be used instead of “Smith”.

If individual members of this family have activated the shared location data during non-panics, all family members may be able to navigate to their family's unique web URL such as www.LocateTheFamily.com/Nepo as illustrated in FIG. 56. When any viewer chooses to view the locations of the various individual members of this family, it may only be possible for the viewer to see the locations of family members who have enabled the shared location data during non-panics. For such users who have activated this function, it is possible for family members such as parents to view the locations of all participating family members, on one website. Any viewer to this website may have the option to commence direct video and/or audio communications with any and all attendees on the website. For instance, a parent may have the ability to instantly video and/or audio communicate with a sibling and also a friend of the user, such as a conference call, all at the same time.

In cases where young children or severe dementia patients may need constant monitoring, users may have the ability to choose to transmit audio, video, location data, and any other available data, regardless of whether or not a panic has been triggered. This may require large amounts of bandwidth, therefore users may be aware that transmitting such data might exceed their allotted monthly bandwidth allowance.

More commonly, in other cases, it may be possible for users to choose to only transmit location data during non-panics, but not to transmit audio, video and other data during non-panics. This may be commonly used by families who wish to keep track of the users' locations, without using excessive bandwidth required to transmit vantage point video and other data-heavy transmissions.

In other cases, such as severe dementia patients, it may be possible for users to transmit all available data, but this may require that the user actively select this option before it transmits the data.

In a case where one or more family members trigger panics, the rescuers may view location and all other vital data from multiple family members on the same family website as illustrated in FIG. 56.

In a case where one or more family members enable the safe journey monitor, viewers of the website such as parents may have the ability to monitor the progress of multiple family members as they progress towards their respective destinations, all on the same website screen.

In certain embodiments, the present application may include a more menu selection. The following options and functions may reside the in the more menu which may be reached by pressing the more menu button 12 within the application: quit ULP; I am okay/send false alarm message/non-dangerous emergency warning; conference call; panic message status; test panic; general preferences; 24/7 ULP rescue center; add/edit emergency contacts; edit personal info; add/edit profile picture; pair ULP with designated physical devices including panic triggers, medical monitoring devices, audio and video recorders, among other accessories; quick start instructions; complete instructions; about ULP; and the like.

The following may include the description of the buttons which may be selected within the more menu. If no panic is currently active and the user selects quit ULP from the more menu, or quit at the bottom of the application screen, the application may quit without requiring a password. If the user is not quitting the application, but instead is merely canceling the active panic because they have emerged safely from a crisis, the user can select the cancel panic button 44 as illustrated in FIG. 6. The user may be prompted to enter their password. When the correct password is entered, the following pop up notification may appear on the screen: “The panic has been canceled and ‘I AM SAFE!’ messages have been sent. Contact rescuers to confirm your safe status.” After the user confirms, the pop up message may disappear, the user's smart phone screen may automatically display the mobile internet browser, and the user may be automatically taken to their own rescue website where they may text and/or voice and/or video chat with rescuers and emergency contacts who were involved with the rescue. Finally, after the correct password has been entered in order to cancel an active panic, the user's phone ringer may automatically be turned to the highest volume. As explained previously, when a silent panic is triggered, the user's phone ringer automatically changes to vibrate mode, for the duration of the panic. When a panic is canceled, the phone ringer volume may automatically increase to the maximum volume, in anticipation of likely incoming phone calls from rescuers and emergency contacts who will wish to confirm the user's safe status, so the ringer volume increase prepares the user to receive the calls. An example of the “I AM SAFE!” SMS message is provided: “I AM SAFE! Situation is now stable but it was a crisis. U can call me to confirm. If u called 911, call them & say I'm safe.”

An example of the “I AM SAFE!” email message is provided:
Subject line—“I AM SAFE!”
Email body—“[FULL NAME OF EMERGENCY CONTACT]!
I am safe! My situation is now stable but this was a crisis. Call me ASAP to discuss it, and to confirm my safe status. If you called 911, call them back and tell them I'm safe.

### [USER'S FULL NAME]

### [USER'S PHONE #]

### [USER'S EMAIL]

Learn more about this safety/rescue service and sign up yourself at http://www.UltimateLifeProtector.com.”

If a panic is active, the panic may first be canceled before the application can quit, and as explained above, a password may be required to cancel active panics. If the user attempts to quit the application during an active panic, they may first be prompted to enter their password. If the correct password is entered, the same pop up notification as above may appear on the screen: “The panic has been canceled and ‘I AM SAFE!’ messages have been sent. Contact rescuers to confirm your safe status.” After the user confirms, the pop up message may disappear, the ULP application may quit, and the user's smart phone screen may switch to the Internet browser, where the user may be taken to their own rescue website where they can text and or voice and or video chat with rescuers and emergency contacts who were involved with the rescue. As further explained below, the user may also start an audio and/or video conference call which can involve multiple rescuers.

Once the correct password has been entered in order to cancel an active panic, the user's phone ringer may be automatically raised to the highest volume. As explained previously, when a silent panic is triggered, the user's phone ringer may automatically change to vibrate mode for the duration of the panic. When a panic is canceled, the ringer volume may automatically increase to maximum volume. After the serious crisis has ended, it is no longer necessary for the user to maintain silence such as if the user were hiding from an attacker. After a serious crisis has ended, it is likely that the user's emergency contacts may wish to speak with the user, so that is the reason why the ringer may automatically increase to the maximum after the panic has been canceled, to ensure that the user doesn't miss these important calls, SMS and other communications. In certain embodiments, if the user attempts to quit ULP during an active panic, or if the user only attempts to cancel the active panic, and they enter a designated false password, for instance “1313”, a pop up message appears which reads, “False Alarm Messages Have Been Sent and the panic has been canceled.” Then the screen shows “ULP QUITTING . . . ,”, and finally the screen switches over to the standard home screen of the smart phone. As the ULP application screens disappear from view, the panic processes may continue. The user's location continues to update at regular intervals, audio, photo, video and all medical data continue to stream to the rescue website, and rescuers continue with the rescue attempt. In certain embodiments, if the user wishes to deceive an attacker by falsely shutting off the power of the phone, the user may select the “power phone off” button in the more menu. If the user enters the designated false password, the phone may appear to shut down as normal, with the standard shut-down process shown on the screen. The user may show this false power shutdown to an attacker, to convince them that the phone power has been turned off. As detailed above with the false quit, while the phone appears to have been powered off, all data including the user's location, audio, video, medical data and the like, continue to transmit to the website. This power-off deception is meant to convince an attacker that the phone has been turned off, when in reality, the phone may still be on and continuing to provide data to the website in order to continue to facilitate the rescue.

The designated false password relating to quitting ULP, canceling the panic modes or powering off the phone, may be used to deceive a potential attacker into falsely believing that the user has canceled the panic, powered off the phone, or in the case of panic message status, to deceive the attacker into believing that no panic messages were ever sent. However, if the user simply enters an incorrect password, they may be prevented from canceling the panic, prevented from quitting the application, and continually prompted to enter the correct password until they either stop attempting to access password-restricted features, or until the correct password is entered. Only after the user enters the designated false password may any of the above deception take place.

If the user suddenly discovers that they have accidentally triggered a panic while they are safe, the user may press the false alarm button 48 on the application screen. If the user enters the correct password, false alarm messages are sent to all contacts.

The false alarm SMS message may be composed of the following information and may be sent to all contacts and, if armed, to the rescue center: “FALSE ALARM! Disregard emergency message I sent. I'm not in danger. If u called 911, call them & say I'm safe. U can call me 2 confirm.”

Concurrently, the false alarm email message may be sent to all contacts and the rescue center, and reads as follows:

### “SUBJECT LINE—“PLEASE IGNORE THE PREVIOUS PANIC MESSAGE”

Email body—“FALSE ALARM! IGNORE EMERGENCY MESSAGE! Please disregard the emergency message you received from me. I am not in danger. If you called 911, call them back and tell them I'm safe. Feel free to call or text me to confirm.

### [USER'S FULL NAME]

### [USER'S CELLPHONE NUMBER]

Learn more about this safety/rescue service and sign up yourself at http://www.UltimateLifeProtector.com.”

If the user did not accidentally trigger a panic, but the user simply wishes to inform their emergency contacts that they are indeed safe, they may select the “I am OK” button which is shown on the More Menu 2 area. When the user selects “I AM OK”, they are prompted to enter their password. If they enter the correct password, the following SMS may be sent to all contacts. “I AM OK. You can call if you wish to confirm.” The following email may be sent to the same emergency contacts:

“Subject—I AM OK!” Email body, “[EMERGENCY CONTACTS FULL NAME], I am OK! If you want to confirm it, you can call or text. Don't worry!

### Love,

### [USER'S FULL NAME]

### [USER'S CELLPHONE NUMBER]”

If the user wishes, either during and/or after an active panic, if the circumstances of their crisis are such that the user is able to speak out loud with the rescuers, the user may select conference call from the More Menu, within the ULP application. After selecting conference call, the user arrives at a screen which may list the user's emergency contacts, the rescue center, and the number of the nearest public rescue service to the user. Next to each contact, there may be a call button. After the user has selected one contact to call, the buttons next to each remaining emergency contact may change to add to call. When the user selects add to call next to any particular contact, that contact's phone may be dialed and added to the conference call. When available bandwidth is exceeded, the screen displays an option to incrementally reduce the bit rate of the current phone connections. The user and rescuers can either engage in a standard audio phone call, and additionally they can engage in a video conference call if the participants possess suitable devices capable of participating in video conference calls. If only certain rescuers possess a phone capable of conducting a video conference call but other participants in the conversation do not possess video conferencing capabilities, those participants may communicate with the video conferencing participants via their standard audio phone, and are able to hear the audio and contribute audio to the conference call.

In addition to the user's capability to initiate a conference call, rescuers may also possess this capability via the mobile and desktop websites. On the emergency contact info screen, as with the user's application, rescuers may select a listed emergency contact and then press “add to call. If the rescuer's laptop or other computer is fitted with a microphone and speakers, (as with nearly all laptops), they may be able to orally speak with several fellow rescuers. As with the user application, on the website, rescuers may incrementally reduce the bit rate of the phone communication if the available bandwidth has been exceeded.

In certain embodiments, when the user selects panic message status, they may be prompted to enter their password. If they enter the correct password, a pop up screen may appear showing whether or not the panic SMS and email messages were successfully sent. For instance, if the user is in an area with low or no cell phone signal, it is possible that the emergency messages were not yet successfully sent. In such cases, the application may constantly re-attempt to send the messages as soon as cell tower, WIFI or other signals become available.

In certain embodiments, if the user enters the designated false password, when the user selects panic message status, a pop up screen may appear which may read, “No Panic Triggered. No Messages Sent.” This may be the case regardless of whether or not the user actually has adequate cell tower or WIFI signal to send a message. It is meant to deceive an attacker into believing that help is not on the way, regardless of the truth.

In certain embodiments, when test panic mode is selected from the Menu Items, the user may be presented with the same panic modes as are normally present on the ULP application home screen, but in this case, it is only a test version of that panic mode. The test panic mode may include test silent panic 2, test loud panic 4, test medical panic 6, and a test safe journey 8. When the test panics are triggered, the functionality may be nearly identical to the non-test version of the same panic mode as mentioned above. However, in certain embodiments, the following may include a set of differences:

A) Instead of the standard SMS panic message, in a Test Panic, the following SMS panic message may be sent to the emergency contacts, but not to the Rescue Center, and this message may contain the same unique clickable web link to locate the user:

“Only a TEST. If I were in true danger I'd need you 2 call 911 & tell them 2 locate & rescue me @ http://www.LocateLovedOne.com/[UNIQUE USER NAME]”

B) Instead of the standard email panic message, the following email may be sent to all emergency contacts, but not to the Rescue Center:

Subject—“TEST PANIC from [USER'S FULL NAME]”

### Email Body—“Hello [NAME OF EMERGENCY CONTACT],

This email is a test panic message from my rescue system called Ultimate Life Protector™. THIS IS NOT AN EMERGENCY. If this were a real emergency, I would need for you to immediately call 911 and tell them to locate and rescue me at the following website below. You can click on it now to learn my location, hear audio, among other resources which could be used in a real emergency. Please explore the website now so you can learn how you can help during an emergency.
http://www.LocateLovedOne.comi[UNIQUE USER NAME]
Thank you for agreeing to help me if I'm in danger!

### [USER'S FULL NAME]

### [USER'S CELL PHONE NUMBER]

### [USER'S EMAIL ADDRESS]”

C) Even if the Rescue Center is armed, when the user triggers any panic from the test screen, no test panic messages are sent to the rescue center.

D) If the user selects test safe journey, the timer and monitor work as normal, but if the countdown reaches zero, the above test panic messages may be sent to the emergency contacts, not to the rescue center.

In certain embodiments the user may view and alter the general preferences by selecting “General Preferences” from the more menu within the ULP application:

A) Screen sleep may be disabled during ULP use, to keep the ULP screen at the ready by deactivating screen sleep at the top of the general preferences. In this case, the screen may dim, but remains on, so that when the user simply taps the screen once, the brightness may return to the previous brightness setting. This may allow the user to tap loud panic on the app screen whenever the user has the need to deter an attacker, such as a date-rapist, for instance. With the screen sleep disabled, the user is not required to awaken the screen and unlock it before selecting loud panic, or any other function available on the screen.

B) Default mode may be for a pop up screen to appear after the ULP application has been running for 60 minutes, to remind the user that ULP is still running. If the user is safe, they can quit the application. This notification can be deactivated in general preferences.

C) Default mode may be for location pings to send every 30 seconds during normal use, during a panic. When the battery runs below ⅓^{rd} remaining power, a low battery conservation mode may take effect, which may restricts location pings to once every 3 minutes, and may restrict further video and/or audio transmission. Also, when conservation mode is in effect, the screen may sleep when the user is not using it, regardless of the screen sleep setting above in (A). The user can deactivate low battery mode in the general preferences. If deactivated, pings may continue to send every 30 seconds, and all other available functions continue to operate until the battery depletes fully.

D) Default mode may be for safe journey timer to not require a password to cancel the countdown, when the user safely arrives at their destination. If the user wishes to require that the correct password be entered before canceling the safe journey timer countdown, they may choose to require a password in the general preferences.

E) The default emergency service phone number may be 911. For users in countries other than the U.S. with different government emergency phone numbers, (such as 999 in the UK) users can enter the appropriate emergency phone number for their country within the general preferences.

F) The default panic may be silent panic. If the user chooses, within the general preferences, they can select a different panic to trigger as the default. For instance, a user with a severe heart condition might choose medical panic as default. In this case, if the user double presses any available panic button, medical panic may be triggered, and if the user is wearing the optional pulse monitor accessory, for instance, medical professionals can monitor the user's pulse before they arrive on the scene. As an example of setting loud panic to be the default panic, a teen age girl can set loud panic as default before attending an unchaperoned party, to deter potentially intoxicated and aggressive males.

G) The user may have the option to create custom buttons for the app screen, which describe anticipated crises. For instance, if the user suffers with a serious asthma condition, in these preferences, users are able to create a custom “asthma attack” button which appears on the screen. If the user is unable to speak during an asthma attack, they can press this button, instantly notifying rescuers of the nature of the emergency, without speaking. The user can create multiple buttons for several possible crises such as “peanut exposure” “bee sting”, “stroke” and the like.

A predetermined SMS-capable phone number and an email address for the rescue center may appear by default in the application of the present invention, in the menu items. When new software versions of ULP are released, if the rescue center phone number and email has changed, the new contact info is updated into the software. ULP may establish the correct cell phone number and the correct email address with which the user can contact the provided rescue center. This contact info may be automatically present within the software, and if any contact info relating to the rescue center changes, the software may be automatically updated to include these changes, so the rescue center may always receive panic messages while the rescue center is armed.

In certain embodiments, it is also possible for the user to alter the emergency phone and email address. One situation where it might be appropriate for users to decide to alter the rescue center contact info would be for a college student who has 24/7 campus security available. The user may input the contact information for her specific campus rescue authorities, so when her rescue center is armed, campus security is dispatched to rescue the user.

When the user triggers their very first test panic after signing up for the service and entering emergency contact info, an invitation email may be sent to all the new emergency contacts. In the aforementioned case of a college student, campus security receives the invitation email, the security service may communicate with the user, and understand how to take advantage of ULP rescue features to rescue the user if campus security receives a real panic message from the user, during a true crisis.

If the user determines her situation is such that she is able to orally speak with the rescue center during a crisis, she can call the rescue center directly by simply pressing the call rescue center button in the menu items, on the 24/7 ULP rescue center screen. In such cases, the rescue center may talk to and comfort the user while arranging for the rescue to proceed.

In certain embodiments, there may be a light version. For users who sign up for so-called light service, the rescue center described above may not be available, but the user may be offered the ability to enter contact information for a primary rescuer. In cases where college students have 24/7 security available on their college campus, for instance, light users may enter contact information for their campus security as the designated primary rescuer.

In certain embodiments, if the light user disarms the primary rescuer, when the user triggers a panic, only the regular emergency contacts may receive the panic messages. The primary rescuer, such as campus security if applicable, may not receive panic messages when the primary rescuer is disarmed. When the primary rescuer is armed, the designated primary rescuer may receive the panic messages. This disarm function may allow light users to trigger panics in non-dangerous situations, such as to be liberated from an unpleasant conversation at a party. If the user plans to use the panic in such a non-dangerous situation, the emergency contacts may be notified in advance, so it is not treated as a life-threatening emergency which requires professional rescuers. When light users arm the primary rescuer, for instance, if the user has a known severe medical condition, they can enter their doctor's contact info in the “Primary Rescuer” field, it may be understood by the panic message recipients that the user has declared that he is in serious danger. Many intended uses for the disarmed mode during non-dangerous situations are outlined above.

In certain embodiments, when the user first installs the application of the present invention, the user may be prompted to enter the cell phone numbers and email addresses of their family and dose friends, who the user determines as the best people to receive panic messages if the user triggers a panic, and for these designated people to agree to act to rescue the user in such circumstances. Within the more menu section of the application, the user may add additional contacts to the list, and edit the existing contact information whenever they wish. When the user first installs the application of the present invention, the user may be prompted to enter their own key information, so it may be available to rescuers in case of emergency. Users can update this information at a later date from the more menu. The information which the user may be prompted to enter is as follows; a full name; a home address; an email address; a cell phone number; any pertinent medical information such as blood type, allergies, bee sting allergies, asthma and the like.

When the user first installs the application of the present invention, the user may be prompted to take a picture of themselves with their phone. This user photo may be displayed on the rescue website, so rescuers may be able to identify the user during an emergency. After the user takes the picture, before submitting it to the ULP server, the user may be able to view the picture, to determine if it is suitable. If the user wishes, they can retake the picture until a satisfactory picture has been taken.

Further, users may be able to return to the user photo section at a later time, to take a new picture of themselves. When the user is satisfied with the new picture, the user may upload the picture to the rescue website. For smart phones which include a self-facing camera, where the user can view themselves in the smart phone screen while taking the picture, this mode may automatically be used when such a self-facing camera is present, and when the user arrives at the user photo screen via the more menu, the existing user photo may be displayed. If the user selects a take a new photo button, the screen may change to become a live viewfinder, and when the user selects a snap photo button, the photo is taken. The most recent photo of the user remains on the screen. If the user is unhappy with that picture, the user can select take a new photo button again. Once the user approves of the photo, the user may upload the photo to the website, and the user photo is sent to the website, and the ULP application screen may return to the more menu section.

For users with smart phones that do not include a self-facing camera, the main camera on the phone may be used. A pop up screen may appear which may read “It's easiest to take your photo in front of a mirror, so you can see the phone's screen in the mirror. This way, you can make sure your face is centered.” The user may close this popup window after reading the message. When the user selects a snap photo button from the screen, the new photo may be taken. All button options may be the same with the self-facing camera and the forward-facing-only cameras. Once the user uploads the approved photo, rescuers may see this photo on the user's website whenever a panic is triggered.

In certain embodiments, when the user arrives at the “Pair with Bluetooth® accessories” more menu option, the user may be prompted to prepare all related Bluetooth® accessories for pairing. This may be done by placing the devices in pairing mode. Once the accessories are findable, the ULP smart phone application may locate and pair with the devices. Once the devices are paired for the first time, the smart phone may always recognize these accessories whenever the accessories enter the Bluetooth® range of the smart phone. For example, the range may be within 15-30 feet.

The physical accessories which can be paired with the user's smartphone may include, but are not limited to: a main Bluetooth® panic trigger device 52; an ear-mounted video camera 54 with panic button; a pulse monitor bracelet with panic button; a brainwave monitor; a breathing monitor; a medicine distribution chamber; automatically activated electrical cardiac resuscitation pads; nano probe blood monitors; a wireless magnetic charging and blood probe interface pad; and a transdermal medicine distribution patch.

The present invention may further include instruction. Below is an example of these brief instructions directing the user to experiment with the test panic function, and broadly explaining what ULP does, and how it works. It may provide the user with a basic overview of the system, and may contain key information needed to begin learning more about ULP, crucially without contacting the rescue center as the user experiments with the present invention.

Detailed instructions via text, images and video which demonstrate the many ULP features and functions are offered. Users are provided with a web link which they can use to view the instructional videos, text and images on their desktop and laptop/tablet computers, for easier viewing. Within the instructions, an invitation is offered for users to join a blog where different users can communicate with each other, answer questions, and maintain a ULP community. A ULP webmaster may monitor the communications and provide solutions and insights to the user members. Users may also be offered an email address where they can send their queries directly to Ultimate Life Protector, LLC, and also a phone number for verbal technical or other assistance.

The mission statement and contact info for the ULP company may appear as an option within the more menu. Frequently asked questions are listed along with answers. A web link may be provided to the ULP sales and company website which is a completely different website from the rescue website.

The following describes in detail the main physical panic trigger device of the present invention. In certain embodiments, the device may include a thumb sized, rechargeable, portable panic trigger device. This device may be designed to be the “flagship” panic trigger device for most users to use as their primary panic trigger button with ULP. The device as illustrated in FIG. 22, may be designed to be highly portable. In certain embodiments, the device may be around 2.75 inches in length or smaller, and may roughly resemble the size of a standard human thumb. As shown in FIG. 22, a small LED 66 may be present in the center of the panic trigger device 68. When the battery needs recharging, in addition to other actions described below, the LED may blink with a red light continuously until the user recharges the device. When the user successfully pairs the panic trigger device with their smart phone, the LED 66 may flash with a green light for several seconds. The panic trigger 52 is illustrated in FIG. 22. This panic trigger or button may be the only button on the front of the device, so the user may never be confused as to which button to double-press during an emergency.

The device may contain several physical elements with which the user can attach the device to their person. As illustrated in FIG. 23, a metal clip 74 is attached to the rear of the device, allowing the user to clip it to their belt, pocket, waistband, shirtsleeve, pocketbook strap, backpack strap, or anywhere else a clip can be attached. A tightly wound spring 70 may reside at the top of the clip, exerting constant pressure to close (or seal) the clip. A snap button 76, 78 may be present at the bottom of the clip 74. For example, the button 76, 78 may include a male snap button 76, and a female snap button 78, which may abut the electronic trigger device. The user may insert thin clothing in between the button snaps, and then snap the button closed over the users clothing. This firmly attaches the device to the user's clothing. A user may snap the button closed at the wrist area of their shirtsleeve, for instance, and the device may remain securely in place, and always readily available to trigger a panic. Another option is for users to insert a pocketbook or purse strap in-between the dip and close the button snaps. The device may be firmly attached to the pocketbook strap, backpack strap, or other object which the user always tends to have with them at most times.

If the clothing material is too thick to enable the button snaps 76, 78 to dose, for instance if dipped to the waist of a users denim jeans, the device remains relatively firmly in place because the dip 70 may have a tightly wound spring that may exert constant pressure to dose the dip.

As illustrated in FIG. 23, the metal clip 70 may also contain an opening 72 which the user can attach to their keychain.

As illustrated in FIG. 24, a female USB port 80 may be present at the bottom of the device. This port 80 may be used to recharge the device by connecting it to a computer or other USB charging station with a standard male-to-male USB cable as illustrated in FIG. 25. In addition to recharging the battery, this USB port can also be used to upgrade the firmware of the device if and when company officials create and distribute improvements to the firmware to the users.

The user may pair the device with their smart phone once, and after this precedent, the smart phone and designated trigger device may permanently recognize each other when the smart phone enters the range of the Bluetooth® signal, enabling the smart phone to rapidly receive and act upon panic signals sent to it by the panic trigger device.

To trigger a panic with the physical button of the present invention, the user may double-press the panic button 52. It may not be necessary to power the device on first, before pressing the panic button. This and other power related details are explained below. When the button is double-clicked, a panic signal may be sent to the pre-paired smart phone. Double-press (aka double-dick) may be used to prevent most accidental panic triggers. If the user sits on the button, for instance, a panic is not be triggered. Once the panic signal is successfully received by the smart phone, the Bluetooth® device 68 may vibrate. This vibration may serve as confirmation that the panic has been successfully triggered. With this feature, the user can be discreetly reassured that professional rescuers are on the way, without alerting a potential attacker.

The panic button 52 on the device may be designed to be felt with the user's fingers, without looking at the button. In other words, the device can be attached to the user's belt or outer pocket, and the user can feel the button 52 without looking at it, because it may protrude and may be tactile and sharp edged for the user's finger, so they can locate it, feel it, and double press it to trigger a panic discreetly, without the user needing to turn their head to look at the button, so it can be pressed discreetly, without a potential attacker noticing. When the user double-presses the button 52 the button may click in a tactile, noticeable way. In other words, when the user presses the button, a physical click is felt by the user's fingers, so they can be aware that the button has been successfully pressed.

In certain embodiments, the panic trigger device 68 of the present invention may be designed to be smaller than a standard adult thumb size. The size listed may enable it to conveniently attach to any desired part of the user's clothing, for instance the wrist area of a shirtsleeve, for easy and constant access to the device in case of emergency.

The trigger device of the present invention may only be used to trigger the panic from the application on the smart phone. An additional advantage to housing the aforementioned features on the phone rather than on the trigger device is so, if a potential attacker notices the trigger device, they can seize it and destroy it, but this does not interfere with the rescue, because the location, audio and other data continue to stream from the user's smart phone, which may remain hidden in their pocket or purse during the entire crisis. It may not be necessary a user to physically interact with the user's smart phone during any portion of the crisis event, in order to trigger a panic which includes all the features described above. In short, attackers may be most likely to notice and destroy or throw away the trigger device because that is the device the user is using/interacting with, but after the panic has been triggered, there is no longer any need to posses the trigger device for the rest of the rescue. An attacker can throw away or destroy the trigger device, while the users smart phone may continue to silently gather and transmit all data needed to rescue the user.

This panic trigger device of the present invention as illustrated in FIG. 22 may be designed to permanently remain in a deep hibernation, regarding the power. Therefore the device may never power off and may be always powered on, at an extremely low level of power usage, only using the power needed to maintain a running internal clock. When the user double clicks the panic trigger button 52, the following sequential events, as an example, may begin:

A) The device fully powers on.

B) The device sends a panic signal to the pre-paired smart phone via Bluetooth®.

C) The device vibrates when it receives confirmation from the smart phone that the signal has been successfully received. This vibration informs the user that the panic has been successfully triggered.

D) The device reenters deep power hibernation.

In certain embodiments, every 2 weeks, the device may be scheduled to automatically power itself fully on, to run a self-diagnostic process to assess the current state of the power supply. In certain embodiments, if the diagnostic process determines that the battery contains more than ⅓^{rd} remaining battery power, the button may reenter deep power hibernation. In such embodiments, if the button contains less than ⅓^{rd} remaining battery power, the device may not reenter power hibernation, and the LED light at the top of the device may constantly blink brightly with a red color, to notify the user that the battery is running low, and the device must be recharged.

In certain embodiments, if the diagnostic test reveals that the battery has reached less than ⅓^{rd} remaining power, the panic button device may send a signal to the user's smart phone, instructing the smart phone to send an email and SMS to the user, reminding the user that it is time to recharge their panic button device or to add a new battery. After the panic button has been fully charged, a different SMS and email message is sent to the user, notifying them that the device is now fully charged. This deep power hibernation solution may enable the device to function without recharging for several months, which may enable the user to attach the device to an item which is with them at all times for several months. In short, the user's ability to instantly and discreetly summon assistance can be constantly available to a user, without the user having a requirement to interact with the system for several months. As mentioned above, since the user is automatically reminded when the device must be charged, the user may be free to ignore the existence of the device until it is needed, because the automatic reminders may help ensure that the device always contains adequate power with minimal user thought or intervention.

In certain embodiments, the present invention may include a scalable server. A web server may be commissioned and configured to facilitate data exchange between the user, loved ones, the 24/7/365 rescue center and a dedicated mobile/desktop website. The server capacity may be predetermined to be instantly and automatically expandable, so that a sudden increase in usage causes an automatic transfer of the necessary resources to increase server capacity sufficient to serve the increased demand.

In certain embodiments, a dedicated mobile and desktop website may serve as the central data clearinghouse, where all data useful in facilitating the user's rescue may be available to rescuers and loved ones. When the user triggers any panic, the registered loved ones and the 24/7/365 rescue center may receive an SMS and email nearly instantly, indicating that the user is in grave danger.

Inside the SMS and email, the individual user's own unique clickable web link may be automatically provided. As illustrated at the top of FIG. 26, the user's unique web link may bring them to the rescue website. An example of the format of the web link may include: “www.LocateLovedOne.com/[UNIQUE USER NAME]”. Those who receive the message with the embedded clickable web link may simply call either 911, or may also call the nearest governmental rescue precinct to the user if the user is in an area where the worldwide local database of governmental rescuers provides for the user's particular location, to instruct them to visit the user's website. In other words, the ULP database of local governmental rescue precincts, such as police and ambulance services, can provide the panic-message-recipient with the nearest police and ambulance contact info 104 to the user's current location, as illustrated in FIG. 26.

In certain embodiments, if the panic message recipient lacks access to the internet, the message recipient/rescuer can simply call 911, and instruct 911 to view the users unique web address because the user faces potential danger. Emergency contacts may explain to the 911 operator that all ULP users understand that triggering a panic is an indication that they face danger, and that they need to be rescued.

Once professional rescuers have been rapidly notified of the crisis, and are given the user's unique web link, with their own smart phones and desktop or tablet computers, the rescuers may be instantly armed with the following array of data points and resources which can be used to rapidly facilitate the user's rescue from any number of dangerous crises: user's current location; a local emergency dispatch database; user's location history; user's previous route path; audio; directions to the user; photo/video from the scene; ear-mounted audio/video camera; photo of the user; emergency contact info; instant text chat amongst rescuers and/or users, instant verbal and video communications amongst rescuers and/or users; user medical info; panic status; user's home address; pulse monitor; brainwave monitor; breathing monitor; nano-blood probes; medicine distribution patches; electrical cardiac resuscitation pads; and the like.

As illustrated in FIG. 26, the user's location 24 may appear in the center of the desktop website as a brightly colored icon labeled “help me” which may appear in the center of the map. The mobile website with the same information is shown in FIG. 27. Every few seconds, when the user's location is updated, the help me icon may move to the user's updated position. In certain embodiments, if the rescuer accidentally scrolls away from the help me icon on the map and loses track of the icon, the user may select user's current location button 82, 108 on the desktop website, as illustrated in FIG. 26 and on the mobile website, as shown in FIG. 27, after selecting the press for menu items button at the top of the mobile screen, the mobile website menu items 132 may be shown, as illustrated in FIG. 28.

When the user's current location button is selected, the HELP ME icon may center on the map. The local emergency dispatch database may include the following. A comprehensive database may be used which contains contact info for all local, professional, governmental emergency dispatchers, which data are stored on the dedicated server, for all localities worldwide. After the user's location has been determined during a panic, the nearest governmental rescue precinct contact info 104 may be gathered from the server, and the phone number for that local precinct may be displayed on the website, at the top of the map, as illustrated in FIG. 26. Loved ones and the 24/7 ULP Rescue Center may immediately contact the local governmental rescue dispatcher nearest to the user, when they arrive at the website, after the panic has been triggered.

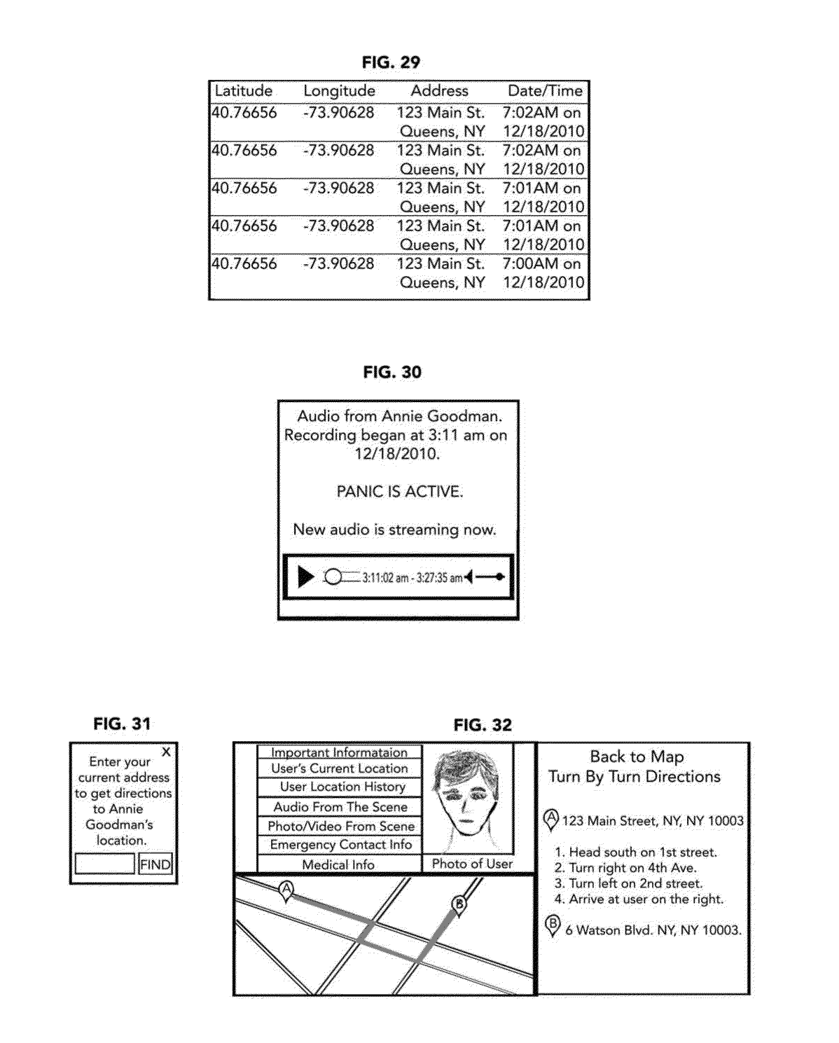

In certain embodiments, when rescuers select the user location history button 84, 130 on the mobile and desktop websites, as illustrated in FIG. 26, and FIG. 28, a screen may appear which shows the user's previous locations, in increments of several seconds. An approximate street address and the latitude/longitude coordinates for the user's location may be shown with each data ping, as illustrated in FIG. 29. The user may be able to adjust the frequency of the sending of the location pings within the application preferences. A higher frequency of pings per minute may improve the rescuer's awareness of the user's location, but it may also use additional battery power. The default setting may be for the pings to be sent in 30 second increments.

Using the present invention, rescuers may be able to see colored lines on the map which represent the user's past movements, beginning when the panic was first triggered. On the mobile website, as shown in FIG. 28, the user selects view route path button 128 from the menu items, and the colored lines may appear on the map. On the desktop website, the colored lines representing the user's previous movements may appear on the map automatically. These colored lines may be easily seen on the website.

When any panic is triggered, audio may be recorded live from the user's smart phone, and the audio signal may be streamed to the website. Each separate audio recording may be listed with the time and date of the audio recording. Rescuers may listen in near real-time to audio from the scene of the crisis, by selecting the audio from the scene button 86, 126 on the desktop website, as illustrated in FIG. 26 and FIG. 28. When the rescuer selects the audio from the websites, they may view all listed audio files with the time and date shown. When the rescuer selects any of the displayed audio files on the mobile and desktop websites, the audio player appears as illustrated in FIG. 30. The audio counter on the audio player may appear as a clock. This may enable listeners to note the time of day when each moment of the audio recording took place, which can provide data to investigators, both during and after the crisis. When the rescuer rewinds the recording, the clock may also rewind, showing the time when that portion of audio took place. Rescuers may be able to listen to the near-live audio as it continues to stream, and may also be able to rewind to earlier portions of the recording, as new audio continues to record and transmit. The rescuer may return to the most recent, near-live audio by forwarding to the end of the available recording. From there, near-live audio continuously streams as long as the panic remains active, onto the rescuers mobile smart phone, tablet, desktop, laptop or any other internet-enabled computer.

Rescuers and emergency contacts may be instantly given directions to the user's location. Rescuers may select/press the help me icon 24 on the map as illustrated in FIG. 26. A blank address-field may appear after the help me icon 24 is pressed, as illustrated in FIG. 31. The rescuer may enter their own current address, and the user may be provided with turn-by-turn directions to the user's current location, as illustrated in FIG. 32. Colored lines on the map may represent the suggested route to the user. These colored lines may be easily seen on the website, but impossible to see in the submitted black & white drawings and screenshots.

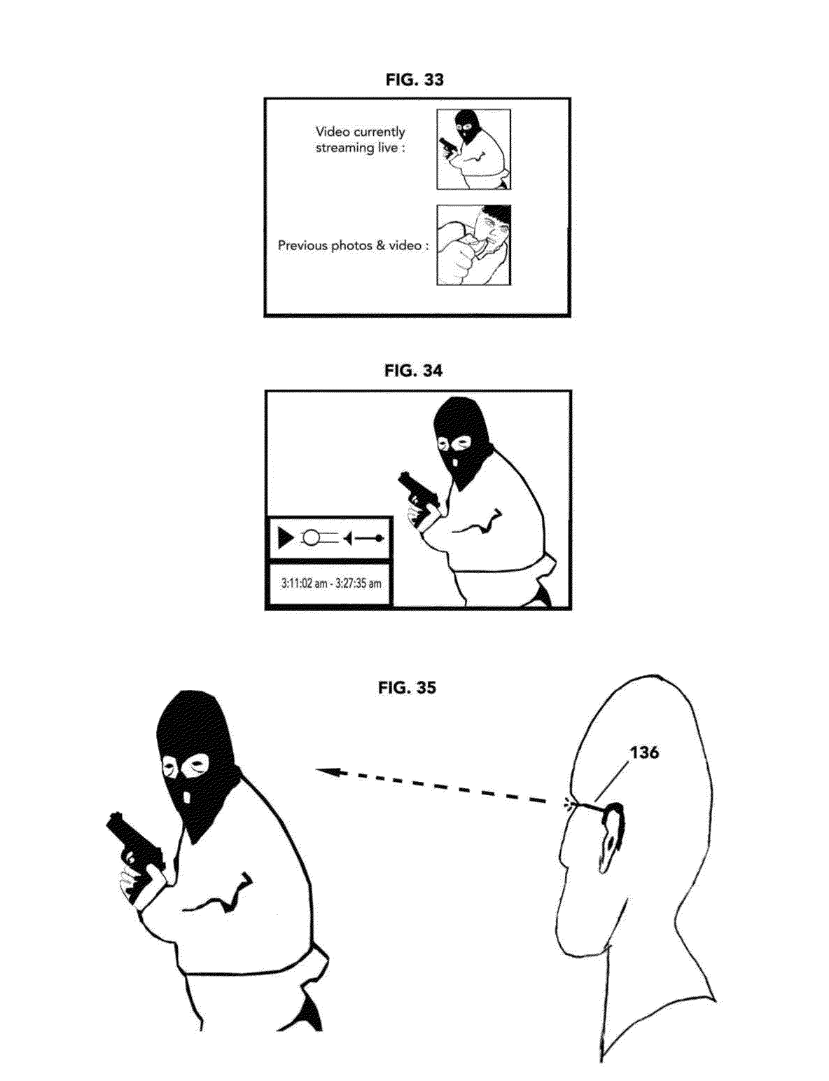

In certain embodiments, when the panic is first triggered, the user's smartphone may take a photo and send it to the website. If the user possesses the optional ear mounted video accessory, rescuers can view near real-time video from the user's vantage point. The video signal may be transmitted from the ear-mounted device via Bluetooth® to the user's smart phone, and the smart phone may stream the video data to the mobile and desktop websites. When the rescuer selects the photo/video from scene button 124 on the mobile and/or desktop websites, if video and/or photos are available, they may be displayed as thumbnails, as illustrated in FIG. 33. When the rescuer selects one of the available video thumbnails on either website, the video player screen appears, as illustrated in FIG. 34. On the desktop website, if the user has streamed video in a panic, the streaming video 98 may automatically appear on the website, as illustrated in FIG. 26.

If the user possesses the designated ear-mounted audio/video accessory, rescuers may be able to view near real-time video, from the user's precise vantage point. This may be achieved by providing a small, ear-mounted video accessory. In certain embodiments, the camera lens may be roughly the width of a paper dip, and may be designed to jut out in front of the user's ear, pointing forward. The device may snugly adhere to the wearer's ear. The camera angle may provide rescuers with video from the user's vantage point, which may greatly enhance the rescuer's understanding of the user's predicament. In addition to the audio and video, the ear-mounted device may also serve as an additional panic button. In certain embodiments, a panic trigger button may be available on the side of the device. The user may double-press the button for a panic signal to be transmitted to the user's smart phone via Bluetooth®. When the panic has been successfully triggered, the ear-mounted device may vibrate, to give the user confirmation that the panic was successfully triggered.

In certain embodiments, the professional rescuers may be provided with a photo of the user on the website, which may enable them to identify the user during the rescue. As mentioned in the signup section, the user may be prompted to take a picture of themselves as they set up their profile. To view the user's photo, rescuers may select “Photo Of User” from the menu items on the mobile website. The user photo may appear automatically at the top of the desktop website. Underneath the photo, the time and date when the photo was taken may be listed.

When rescuers select “Emergency Contact Info” on the mobile or desktop website, rescuers and loved ones may see the email addresses and cell phone numbers of all designated emergency contacts, the nearest police/ambulance and rescue center. When the rescuer taps on any phone number on their smart phones, the rescuer may be presented with the option to chat via text and or video, send an SMS or place a phone call to that person. If the rescuer selects SMS, they may be instantly transported to an outgoing SMS screen with the emergency contacts phone number automatically entered. If the rescuer selects phone call, the standard phone call screen may appear, and a call may be automatically placed to that contact.

After receiving the SMS and email panic message, all emergency contacts and professional rescuers may instantly communicate with each other in the designated text area on the home screen of the website, to share vital information about the user's predicament and previous plans. On the mobile and desktop websites, rescuers may simply enter their name in the chat field and then select a start button 106, as illustrated in FIG. 26. After selecting the start button 106, a standard chat window may appear. Various family, friends and professional rescuers may instantly share key information to help with the rescue. The emergency contacts may enter text at the bottom of the window, and after completing the message, they submit the text, and the message may be sent to the upper chat window, as is the standard format for instant messaging.

In certain embodiments, the user may able to initiate an audio conference call between themselves and the various rescuers. In addition to the user's capability to initiate an audio or video conference call with rescuers, the rescuers may also possess the capability to initiate audio or video conference calls without the user's participation, via the mobile and desktop websites. On the emergency contact info screen, as with the user's application, rescuers may select a listed emergency contact and then press an add to call button. If the rescuer's laptop or other computer is fitted with a microphone, video camera and speakers, they may orally and/or visually converse with several fellow rescuers at once. As with the user application, on the website, rescuers can incrementally reduce the bit rate of the phone communication, if this becomes necessary for any reason.

In certain embodiments, on the mobile and desktop websites, rescuers and loved ones may be able to see medical information relating to the user, such as blood type, ailments, known allergies, and the like, by selecting the medical info button from the menu items screen. After selecting medical info, a separate window may open which contains all medical information which the user previously entered via the smart phone application. As mentioned above, users may be instructed to enter relevant medical information when they first sign up for application of the present invention, and the users may also update the text for this screen in the preferences section of the application.

As illustrated in FIG. 26, at the top of the website in an informational display box 96, the type of panic may be displayed (Silent, Loud or Medical Panic) the time the panic was triggered may be displayed, and it may be displayed whether or not the panic is currently active or inactive. It may also be displayed if the user sent a “false alarm message”, indicating that they accidentally triggered a panic. It may also be displayed if the user entered a “designated false password”, intended to mislead an attacker into believing that the user has canceled the panic.

As mentioned above, when the user has launched an I am safe signal, the following may be displayed in the panic status section of the website: “I AM OK. at 7:36 AM, on Feb. 15, 2013”. Call to confirm if you wish.”

The informational display box 96 may be shown in the same area as all panic status updates, in FIG. 26. When the user selects the I am safe option or false alarm message option, the user's phone ringer may automatically increase to the maximum volume, to enable the user to hear phone calls from rescuers who will likely wish to call the user to confirm that the user is indeed safe.

In certain embodiments, further information may be displayed on the website. For example, the user's home address may be listed at the top of the desktop website, in addition to the user's cell phone number. On the mobile website, rescuers can find the user's home address by selecting the address of user button 114 as illustrated in FIG. 28.

If the user has the optional pulse monitor, rescuers may be able to see the real time heart rate of the user in the medical info section of the website. When the user's pulse exits the safe range, a medical panic may be automatically triggered and the website may flash red, indicating that the user's pulse has reached a dangerous level. This may be displayed on the front page in the panic status section of the website, regardless of whether the rescuer has navigated to the medical info section of the website. Therefore, when the user's pulse reaches a dangerous level, the user's pulse status may be forced to the front of the website to instantly notify all rescuers of the user's current pulse status.

If the user has the designated brain wave monitor, rescuers may be able to see if the user is having a seizure, a stroke, or many other brain conditions. The brainwave monitor may automatically send the user's current brain status to the website, so rescuers can understand the nature of the user's brain related issue. In addition to the visual brainwave monitor, a basic text description of the user's brain-related condition may be shown next to the brainwave monitor. As with the pulse monitor described above, if the user is experiencing a brain related crisis, a medical panic may be automatically triggered, and this issue may be displayed in the panic status section of the website, and the applicable visual monitor may be automatically pushed to the front page of the website, regardless of whether or not the site viewer selects medical info.

If the user is wearing the optional breathing monitor, rescuers may be able to determine whether or not the user is breathing, in the medical info section of the website. If there is an indication that the user has stopped breathing, or is not breathing within a safe range, a medical panic may be triggered and the user's breathing status may be pushed to the front of the website.

If the user has injected the designated nano blood probes, the rescuers may determine whether or not the user's vital blood levels are normal, including whether or not the user's blood reveals the need for a new dose of essential medication. This information may be shown on the website in the medical info section, and if the situation becomes urgent, the front of the website may be notified with the current urgent status. The multiple blood probe monitors, which may be roughly the size of red blood cells, may continue to travel throughout the user's blood stream until they are removed with a doctor's assistance. The blood probes and other optional accessories are detailed below.

If the user is in need of a new dose of essential medication, and the user is wearing the designated transdermal medicine distribution patch, the users who have been instructed by their doctors to receive regular doses of prescribed medicine may be able to program the patch to release a predetermined dosage at predetermined time intervals. The user may also be able to receive medicine if the blood probe determines that a new dose is unexpectedly needed, and the blood probe communicates with the medicine patch, instructing it to release the correct dose of medicine to the user, which is distributed through the user's skin. The website may inform rescuers of the user's situation regarding their medicine in the panic status section of the website and also in the medical info section on the website.

In certain embodiments, a medicine dispersal and containment chamber may be surgically implanted in the user. When the blood probe determines that the user urgently requires large doses of the medicine in question, (such as the commonly large doses needed for anti epileptic seizures) the medicine distribution chamber releases the designated amount of the drug. The chamber may be surgically positioned so that the refill entrance may be readily accessible beneath the skin. The doctor may inject the refill of the medicine directly through the users skin, into the distribution chamber. If, for instance, a user suffers from severe epileptic seizures, when the brainwave monitor determines that a seizure has begun, the brainwave monitor signals the ULP application, and from the smart phone, the application may direct the proper dose of medicine to be released from the implanted large dose medicine distribution chamber. When the chamber releases the medicine, the user's medicine status may be displayed in large type font at the top of the home screen of the website, informing all rescuers. Also, if the user's medicine status is in crisis, this info may be sent via SMS and email to all emergency contacts.

In certain embodiments, two portable pads may adhere to the user's chest with an adhesive. The pads, which contain sensors and local CPU processing capabilities to receive and interpret the sensor readings, may be able to discern whether or not they are correctly fastened to the person's chest, and are also able to detect the user's heart rate at all times. When the heart stops beating, the sensors may recognize this, a medical panic may be automatically triggered, and the pads may administer the correct amount of electrical impulse to defibrillate the users heart. The process may automatically cease as soon as the sensors determine that a safe heart rate has been restored. The user's heart is monitored on the main home screen of the rescue website automatically as soon as the irregular heart-related issue is discovered by the heart sensor/pads. In addition to the visual heart monitor on the website, a basic text description of the user's medical issue may be shown on the front of the website, along with a visual monitor of the user's heart functions. All defibrillation activity may be listed in the panic status section of the website.

In certain embodiments, trained personnel may be utilized and may be prepared to receive a panic signal via methods such as SMS or email from any user, at any hour, on any day, from the rescue center. These trained personnel may await the panic messages from multiple computer centers, located hundreds of miles apart throughout North America. This may be used for continuous service in case a severe local disaster strikes, potentially causing one particular rescue center to lose power. If power is lost in one or even several regional rescue centers, rescue service may not be disrupted because distantly located redundant centers seamlessly continue to provide service. In certain embodiments, the rescue personnel may be instructed to adhere to the following guidelines:

A) When any panic message is received, rescuers first must click on the user's unique web link within the panic message, bringing them to the user's rescue website.

B) Upon arriving at the website, rescuers should immediately begin listening to streaming audio from the scene, and if available, video and or photos. If it is impossible to discern any information useful in determining the severity of the user's situation, the rescuer should contact the nearest rescue precinct to the user, with the correct phone number for this precinct automatically provided on the header of the user's website. After the user's own location is determined, the nearest police and ambulance is displayed, with their contact info.

C) The rescuer tells the local rescue dispatcher that the user is in potentially life threatening danger, and provides them with the user's unique location and information website, “http://www.LocateLovedOne.com/[UNIQUE USER NAME]”. The local professional rescue precinct is instructed to find and rescue the user immediately using the www.LocateLovedOne.com website.

D) After notifying the local police precinct, designated rescuers remain available to communicate with the user's emergency contacts via multiple ways including the chat text, SMS, audio and/or video section on the home screen of the rescue website, described earlier.

E) The rescue center maintains continuous communications with the public rescue dispatcher throughout the crisis and relays all status updates to the loved ones, emergency contacts, and campus security if applicable.

F) In cases where the user is able to speak freely, under no duress, if the user wishes, they may be able to call the rescue center directly, and the rescue center may connect the user's phone call as with a conference call, as detailed above, so the user can simultaneously speak with the rescue center, the local 911 precinct, and possibly with the user's parent, guardian or other loved one if the user suggests it to the rescue center. If the user initially believes that it is safe to place a phone call to the rescue center and rescuers, but suddenly learns that it is not safe for this conference call to be audible, there is a large “MUTE” button on the user's screen during the call. When any participant selects mute, all audio from that participant's computer is silenced, and all other website attendees can see that this participant has silenced their audible audio. To be clear, if the user selects mute as described, audio from the user still continues to stream to the website where it is recorded for current and or later use. Therefore, when the user selects mute, they are silencing audible audio from being heard in their present location, on the user's own smart phone. When this mute mode is activated, as normal, sound from the user's position is discreetly transmitted to and recorded on the website for rescuers to examine in near-realtime, and also at a later time.

G) If the rescue center receives a “False Alarm Message”, or if the user cancels the panic, the rescue center is directed to immediately call the user's cell phone, to confirm that the user is indeed safe. If the rescue center determines that the user is safe, all emergency contacts and 911 may be immediately notified by the rescue center.

H) If the rescuer is able to reach the user via phone, the rescuer may ask the user to say their password. If the user says the correct password, the local public rescue precinct may be immediately notified that the user is now safe, and no longer in need of professional rescue services.

I) If the user gives the designated “false” password, the rescuer notifies the public rescue precinct that the user is attempting to deceive an attacker, by pretending to cancel a panic, but in reality, the user has purposely given the designated false password, indicating that the user is under duress and is falsely attempting to convince an attacker that the user is canceling the panic mode. In reality, the rescuers continue to search for and rescue the user. Therefore, if the user enters a wrong password, the panic is not canceled, and the user is prompted to enter the correct password. Only when the user enters the designated false password do the actions described above take place.

In certain embodiments, the present invention may include the flexible bracelet mentioned above. This flexible bracelet device may contain sensors which constantly monitor the user's pulse. If the user's pulse stops or becomes dangerously irregular, the bracelet sends a signal via Bluetooth® to trigger a medical panic on the user's phone. From the website, the rescuers may be able to view the user's pulse via a visual pulse monitor, which appears on the front of the website if the user's pulse enters a dangerous range. If the user's pulse is within a normal range, but the user suddenly finds themselves in a dangerous crisis, they can simply double-press the small panic trigger button which may be present on the pulse monitor, to trigger a panic. In addition to sensors which detect the user's pulse rate, the pulse monitor sensors also may be able to detect whether or not the monitor is being worn correctly by the user. In other words, if the user removes the pulse monitor from their wrist, no medical panic is triggered, because the device may detect that it is no longer correctly positioned on the user's wrist.

In certain embodiments, the present invention may include a flexible hat containing electrodes which constantly monitor the user's brain activity. If the user has frequent seizures, for instance, when the user begins to have a seizure, the brainwave monitor may send a signal via Bluetooth® to the user's smart phone to trigger medical panic, and to display the user's real time brainwaves for medical personnel to study, to better understand the nature of the brain-related crisis. On the main screen of the website, in large red letters, it may be displayed that the user is currently having a seizure. The brainwave monitor may detect all brain-related crises such as stroke, blunt impact or seizure, and automatically triggers medical panic. Medical professionals may view the user's brain waves to better understand the type and severity of the brain issue. The sensors on the brainwave monitor also may be able to detect whether or not the monitor is being worn correctly by the user. Therefore, if the user removes the brainwave monitor from their head, no medical panic may be triggered, because the device has determined that it is no longer correctly positioned on the user's head. If the user's brainwaves are safely within a normal range, but the user suddenly finds themselves in a dangerous crisis, they may double-press the small panic button which may reside on the side of the brainwave monitor hat, and a panic is triggered. Therefore, as with other optional accessories, an alternate panic trigger device may be contained on this accessory.

In certain embodiments, the present invention may include a breathing monitor as mentioned above. The breathing monitor may rest in the user's shirt pocket and remain in place with a sturdy metal clip. If the user stops moving/breathing, the device may send a medical panic signal to the user's smart phone. The user's breathing status may be shown on the front of the website if the breathing is dangerously abnormal or absent. The breathing monitor may contain sensors which are able to detect whether or not the monitor is correctly positioned on the user. If the user removes the breathing monitor, no panic may be triggered because the device may detect that it is not being worn. If the user is breathing normally, but they suddenly find themselves in a dangerous crisis, the user may double-press the small panic trigger button which resides on the breathing monitor and a panic is triggered.

In certain embodiments, multiple nano blood probes may be surgically implanted into the user's bloodstream. When, for instance, the blood probes sense that the user is in need of large doses of a certain medicine, (such as anti-convulsant medicine to treat a seizure) the surgically implanted medicine distribution chamber may release the drug, using a similar mechanical procedure as the transdermal medicine distribution patch. Namely, the medicine reservoir remains sealed within the chamber until the robotic levers release the medicine directly into the user's bloodstream when it receives this instruction from the blood probes, brainwave monitor, other related health accessory, or at a predetermined time. If a doctor wishes to schedule a time for the medicine to be released, the user and/or doctor may interface with the device and program the desired instructions. The chamber may be surgically positioned so that the refill entrance may be readily accessible near the surface of the user's skin. The doctor may inject the refill of the drug directly through the user's skin, into the distribution chambers. There may be multiple, separate chambers designed to house different medicines, all separate from each other, and all sealed off from the user's bloodstream until the user needs them. The material surrounding the reservoir responds to the injection by forming a seal over the newly punctured hole. This is done to prevent medicine from seeping into the user's blood stream until it is desired. Therefore, after an injection is carried out, the puncture caused by the injection may be automatically re-sealed, to prevent any medicine from escaping the medicine reservoir until the chamber receives the command from the user and/or doctor.

For example, if the user in question is allergic to bee stings, when the blood probe determines that the user has been stung by a bee, the probe signals the ULP application, and from the smart phone, the application directs the proper dose of epinephrine to be released from the implanted medicine chamber. The chamber may include several sub-chambers, which can each contain different medicines to be released on different schedules. For instance, one chamber may contain epinephrine, and 4 chambers may contain insulin. Regarding the power for the device, as with the blood probes, the medicine chamber may be recharged with a wireless platform. When the battery runs low on the chamber, the chamber sends a signal to the user's phone, directing the user to self-send an SMS and email, informing the user and/or doctor that it is necessary to recharge the medicine chamber. The user may hold the charging platform near the location of the implanted device, and when the charge is complete, the chamber may instruct the user's phone to send the user an SMS and email on their smart phone, notifying the user that the charge is complete. When the blood probes or other devices direct the chamber to release the medicine, the user's medicine status may be displayed on the home screen of the website, informing all rescuers.

In certain embodiments, the present invention may include automatically enabled cardiac defibrillation pads. The two portable pads may stick to the user's chest with an adhesive. The pads, which contain sensitive sensors and local CPU processing capabilities to receive and interpret the sensor readings, may be able to sense whether or not they are correctly fastened to the person's chest, and also able to detect the user's heart rate. When the heart stops beating, the sensors detect this, and the pads administer the correct amount of electrical impulse to defibrillate the user's heart. The process may automatically cease as soon as the sensors determine that a safe heart rate has been restored. A medical panic may be triggered and all heart information may be pushed to the front of the rescue website. The pads may be recharged with the wireless charging pad.

The ULP nano-blood-probes, as mentioned above, may circulate through the user's body continuously until removed. The probes may be roughly 5 micrometers in length, slightly smaller than standard red blood cells. The devices may be constructed with carbon atoms in a diamond pattern to maximize their strength. They may contain CPU, robotic arms capable of grasping and analyzing various cells and other objects; with sensors capable of detecting the presence and concentration of any physical substance. The probes may be able to seek out and destroy certain designated cells with a robotic drill and vise, such as designated cancer cells or designated bacteria, as directed by the user and their authorized medical advisors. In addition to recharging the battery via the magnetic charging pad, the blood probes may have the ability to harness energy present in glucose in the user's bloodstream. The probes may be able to replenish their batteries by converting the glucose into usable electricity.

After injecting the blood probes, the user's blood levels may be constantly monitored by the probes to ensure that proper levels of all substances are within healthy ranges. If, for instance, the user requires a steady dose of medicine to prevent the onset of psychotic symptoms if the user suffers from severe Schizophrenia, when the blood probes detect that the user's blood is running low on the medicine in question, the probes may send a signal to the user's phone, which then signals the user's medicine distribution patch, or the implanted large dose medicine distribution chamber, to release the appropriate dose of medicine to the user. The blood probes may link with the surgically implanted large dose medicine distribution chamber to release larger doses of medicine than the transdermal medicine distribution patch can contain and administer. The large dose chamber can also slowly release medicine as is necessary to maintain symptom relief for a user with Schizophrenia, for instance, requiring fewer refills than the transdermal medicine patches.

The blood probes may constantly monitor all key blood levels, and if a crisis is detected because, for instance, the user's oxygen or insulin levels are dangerously low, the probes may send a signal to the user's phone, which then triggers a medical panic, notifying all emergency contacts that the user is having a medical crisis. The specific, known details of the crisis as determined by the probes may be sent to the website for rescuers to understand the nature of the emergency. In certain embodiments users and doctors can interface with and recharge the blood probes by using the wireless charging and interface device in addition to the conversion of blood glucose mentioned above.

To charge the battery inside the wireless charging pad, it can be plugged into a wall outlet. Once the charging pad's battery is full, the user may bring the charging pad with them, in a mobile fashion, enabling the user to recharge and/or interface with their blood probes and other accessories while they are away from stationary power. It is also possible to use the charger/interface pad if the battery is depleted, while the pad is plugged into the wall outlet.

The blood probes may be magnetized to the opposite polarity of the charging/interface pad, hence, when the probes arrive at the user's arm during normal blood circulation, and the user's arm is resting on the charging and interface pad, the probes remain stationary when they reach the magnetic field from the charging interface pad. While the probes remain suspended in the magnetic field, the probes are recharged, and the probes may also be reprogrammed with new tasks by the user and their doctor.

The charging and interface pad may link via WIFI to a computer terminal through a secure web portal, with which the user and doctor may be able to transmit new instructions to the probes, as the batteries are being recharged. When the power has been fully restored, the probe may send a signal to the user's phone via the charging pad. When the user's phone receives this signal, an SMS may be sent to the user's phone along with the designated medical contact, to notify them that the probes have been successfully recharged, and when applicable, when the probes have successfully received their new instructions.

With the transdermal medicine distribution patches, users who have been instructed by their doctors to receive regular doses of prescribed medicine may be able to program the patches to release a predetermined dosage at predetermined time intervals. The patches may be attached to the user's skin via an adhesive 138, and once correctly attached, the patches may remain in place, even if the user enters water. As illustrated in FIG. 37, before the patch has been instructed to distribute the medicine, the medicine shield 140 may block the medicine reservoir 142, from contacting the skin. As illustrated in FIG. 38, when the user and their doctor instruct the medicine shield 146 to move to the side on the motorized levers, the medicine reservoir 142 may be directly exposed to the user's skin 144 where the medicine is absorbed into the skin at the predetermined dosage. After the desired amount of medicine has been dispersed, the motorized levers may re-seal the medicine shield 140 blocking further absorption. For example, with a Schizophrenic patient whose doctor prescribes a steady dosage of a medicine, the medicine distribution patch automatically withholds and releases medicine transdermally, according to the instructions entered by the doctor.

The user, while consulting with his doctor, may be able to issue instructions for the transdermal medicine distribution patch through the user's individual web page such as, (www.LocateLovedOne.com/[UNIQUE USER NAME]). The following may include example instructions on how to use the patch:

A) The user and doctor, or anyone who wishes to modify the medicine distribution settings, may prove that they are authorized to modify these settings, by subjecting them to multiple layers of password security.

B) After the correct passwords have been entered, the user and doctor may determine the dosages to be released at appropriate time intervals, or to instantly release upon onset of designated symptoms.

C) The doctor fills the drug reservoir for each patch. Users may utilize up to around twelve patches if there is enough skin available for patches without excessive amounts of body hair. The drug reservoirs can be refilled while they are still adhered to the user's skin, and can also be refilled before the user attaches the patches.

D) Users can recharge the batteries in the patches without removing them from their skin, by holding the wireless charging pad next to each patch, until the patch sends an SMS to the user's phone, notifying them that the devices have been fully charged.

E) The patches may be designed so that the medicine is kept in a separate compartment from the user's skin until it is needed. Therefore, the medicine may not make contact with the user's skin until the user has decided for their skin to make contact, and programmed the device to release the medicine at the desired times via the user's unique web page, such as (www.LocateLovedOne.com/[UNIQUE USER NAME])

When the patches receive an instruction to administer the medicine, a thin barrier slides to the side, enabling the drug reservoir to make contact with the user's skin. Multiple compartments may be available with separate sliding barriers, so the medicine can be deliberately administered in a staggered fashion, at whichever schedule the user and doctor have chosen through the web portal above. In certain embodiments, the patches may interface with the ULP application, website, emergency contacts and the rescue center. For example, the patches may do the following:

A) When all doses are administered, the patches may send a signal to the user's cell phone, and the ULP application may notify emergency contacts, the website and the rescue center that the medicine has been successfully administered.

B) After any dose is administered, the current remaining amount of medicine in the drug reservoirs may also be transmitted to the website. When the sensors in the drug reservoirs determine that a refill is urgently necessary, the patches trigger a medical panic, alerting all emergency contacts and the rescue center of the situation regarding the medicine.

C) If the patch malfunctions and does not successfully administer the medicine, a medical panic may be triggered and the malfunction may be described on the front of the website.

In certain embodiments, when users and doctors instruct the blood probes to assess levels of an important substance, and that substance has fallen below safe levels, the blood probe may signal the ULP application which then may signal the medicine distribution skin patches to release the desired dosage of the medicine in question, directly through the user's skin via the skin patches. For example, the sequential actions may include the following:

A) Blood probe determines that the user is in need of a dose of the medicine available in the skin patch.

B) The blood probe notifies the ULP application.

C) The user's smartphone signals the patches via Bluetooth®, instructing it to administer the correct dose of medicine.

D) When the blood probes observe that the optimal levels of the drug have entered the blood stream, the patch sliding barrier closes, sealing off the drug from the users skin.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention.

What is claimed is:

1. A method for disseminating information regarding a problem, comprising:
providing a mobile device wirelessly connectable to a network;
receiving and storing contact information corresponding to a designated list of information recipients;
receiving, via the mobile device, a signal indicating the problem;
receiving, via the mobile device, information regarding the problem;
transmitting an indication of the problem to a rescue clearinghouse via the network;
prompting a participant of the rescue clearinghouse, different from the user, to make a decision about a course of action regarding the problem; and
at least one of transmitting the information regarding the problem to the information recipients from the designated list and transmitting the information regarding the problem to a government rescue organization, based at least in part on the decision.

2. The method for disseminating information regarding a problem as claimed in claim 1, further comprising a primary panic trigger device comprising a button, wherein receiving the signal indicating the problem is activated by the user double pressing the button, which signals the mobile device wirelessly.

3. The method for disseminating information regarding a problem as claimed in claim 1, further comprising a head mounted camera comprising a button, wherein receiving the signal indicating the problem is activated by the user double pressing the button, which signals the mobile device wirelessly.

4. The method for disseminating information regarding a problem as claimed in claim 1, wherein receiving the signal indicating the problem is activated by the mobile device detecting a preprogrammed verbal phrase.

5. The method for disseminating information regarding a problem as claimed in claim 1, further comprising receiving and storing a specified area, wherein receiving the signal indicating the problem is activated by the mobile device either entering or exiting the specified area.

6. The method for disseminating information regarding a problem as claimed in claim 1, further comprising the step of providing a g-force detector attached to the cell phone; and receiving and storing information of a threshold g-force amount, wherein receiving the signal indicating the problem comprises the mobile phone reaching the threshold g-force amount.

7. The method for disseminating information regarding a problem as claimed in claim 1, further comprising providing a family plan comprising a plurality of mobile devices owned by different members of the same family.

8. The method for disseminating information regarding a problem as claimed in claim 7, further comprising the step of detecting the location of the plurality of mobile devices on the family plan and displaying the location on a shared family Internet website.

9. The method for disseminating information regarding a problem as claimed in claim 8, further comprising:
providing a recording device connected to at least one of the plurality mobile devices and configured to record at least one of audio, video, and image; and
recording at least one of audio, video, and image in real time via the recording device to produce recording information,
wherein the information is displayed on the shared family Internet website.

10. The method of disseminating information regarding a problem as claimed in claim 1, wherein the signal indicating the problem activates a silent panic or a loud panic, wherein the silent panic comprises transmitting an indication of the problem to a rescue clearinghouse via the network without detection, wherein the loud panic comprises transmitting an indication of the problem to a rescue clearinghouse via the network while the mobile device produces at least one of a loud spoken warning, and an emitting light.

11. The method of disseminating information regarding a problem as claimed in claim 10, wherein activating the loud panic comprises selecting a loud panic button icon displayed on a home screen of the mobile device.

12. A method for disseminating information regarding a problem, comprising:
providing a mobile device wirelessly connectable to a network;
receiving and storing contact information corresponding to a designated list of information recipients;
receiving, via the mobile device, coordinates of an intended destination;
tracking the movements of the mobile device from a current location to the intended destination;
transmitting an indication of a problem to a rescue clearinghouse via the network when the mobile device is either no longer moving or is deviating from routes which lead to the intended destination;
prompting a participant of the rescue clearinghouse, different from the user, to make a decision about a course of action regarding the problem; and
at least one of transmitting the information regarding the problem to the information recipients from the designated list and transmitting the information regarding the problem to a government rescue organization, based at least in part on the decision.
